(19) United States
(12) Patent Application Publication
(10) Pub. No.: US 2025/0106894 A1
(43) Pub. Date: Mar. 27, 2025

(54) CONTENTION WINDOW ADJUSTMENT IN A NEW RADIO (NR) SIDELINK SYSTEM OPERATING IN FREQUENCY RANGE 1 (FR-1) UNLICENSED BAND

(71) Applicant: Intel Corporation, Santa Clara, CA (US)

(72) Inventors: Salvatore Talarico, Santa Clara, CA (US); Kilian Roth, Munich (DE); Alexey Khoryaev, Santa Clara, CA (US); Sergey Panteleev, Kildare (IE); Mikhail Shilov, Santa Clara, CA (US)

(21) Appl. No.: 18/833,368

(22) PCT Filed: Apr. 17, 2023
(86) PCT No.: PCT/US2023/065838

§ 371 Date: Jul. 25, 2024

Related U.S. Application Data
(60) Provisional application No. 63/332,129, filed on Apr. 18, 2022.
(60) Provisional application No. 63/349,875, filed on Jun. 7, 2022.
(60) Provisional application No. 63/408,311, filed on Sep. 20, 2022.
(60) Provisional application No. 63/410,535, filed on Sep. 27, 2022.
(60) Provisional application No. 63/421,419, filed on Nov. 1, 2022.
(60) Provisional application No. 63/446,180, filed on Feb. 16, 2023.

(51) Int. Cl. H04W 74/0816; H04L 1/1812; H04W 92/18

(52) U.S. Cl. CPC H04W 74/0816; H04L 1/1812; H04W 92/18

(57) ABSTRACT

Various embodiments herein provide techniques related to adjustment of contention window size for new radio (NR) sidelink (SL) systems. Specifically, embodiments may relate to NR SL systems operating in the frequency range 1 (FR-1) unlicensed band, and using type 1 listen-before-talk (LBT). Embodiments further relate to LBT bandwidth (BW) definitions in such systems. Other embodiments may be described and/or claimed.

### CROSS REFERENCE TO RELATED APPLICATION

The present application claims priority to U.S. Provisional Patent Application No. 63/332,129, which was filed Apr. 18, 2022; U.S. Provisional Patent Application No. 63/349,875, which was filed Jun. 7, 2022; U.S. Provisional Patent Application No. 63/408,311, which was filed Sep. 20, 2022; U.S. Provisional Patent Application No. 63/410,535, which was filed Sep. 27, 2022; U.S. Provisional Patent Application No. 63/421,419, which was filed Nov. 1, 2022; and to U.S. Provisional Patent Application No. 63/446,180, which was filed Feb. 16, 2023.

### FIELD

Various embodiments generally may relate to the field of wireless communications. For example, some embodiments may relate to contention window adjustment in sidelink (SL) communication.

### BACKGROUND

Various embodiments generally may relate to the field of wireless communications.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of new radio-unlicensed (NR-U) SL communication modes, in accordance with various embodiments.

FIG. 2 illustrates an example of an energy detection threshold (EDT) as a function of the output power for different channel bandwidths (BWs), in accordance with various embodiments.

FIG. 3 illustrates an example of a legacy and an adjusted EDT as a function of output power, in accordance with various embodiments.

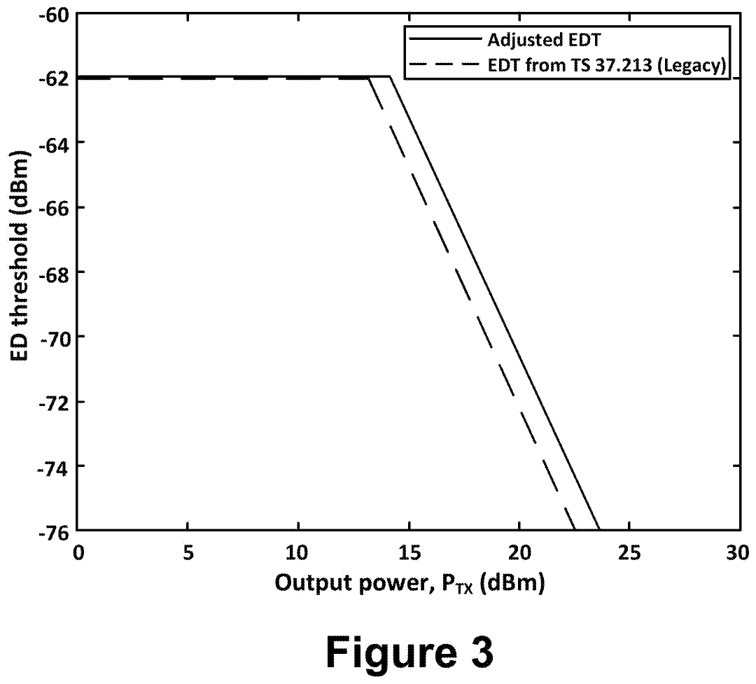

FIG. 4 schematically illustrates a wireless network in accordance with various embodiments.

FIG. 5 schematically illustrates components of a wireless network in accordance with various embodiments.

FIG. 6 is a block diagram illustrating components, according to some example embodiments, able to read instructions from a machine-readable or computer-readable medium (e.g., a non-transitory machine-readable storage medium) and perform any one or more of the methodologies discussed herein.

FIG. 7 illustrates a network in accordance with various embodiments.

FIG. 8 depicts an example procedure for practicing the various embodiments discussed herein.

FIG. 9 depicts another example procedure for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Mobile communication has evolved significantly from early voice systems to highly sophisticated integrated communication platforms. The next generation wireless communication system, fifth generation (5G) (which may be additionally or alternatively referred to as new radio (NR)) may provide access to information and sharing of data anywhere, anytime by various users and applications. NR may be considered to be a unified network/system that target to meet vastly different and sometime conflicting performance dimensions and services. Such diverse multi-dimensional requirements may be driven by factors such as different services and applications.

For instance, in the third generation partnership project (3GPP) release-16 (Rel.16) specifications, sidelink (SL) communication was developed in part to support advanced vehicle-to-anything (V2X) applications. In release-17 (Rel.17), 3GPP studied and standardized proximity based service including public safety and commercial related services and, as part of Rel.17, power saving solutions (e.g., partial sensing, discontinuous reception (DRX), etc.) and inter-user equipment (UE) coordination have been developed in part to improve power consumption for battery limited terminals and reliability of SL transmissions. Although NR SL was initially developed for V2X applications, there is growing interest in the industry to expand the applicability of NR SL to commercial use cases, such as sensor information (video) sharing between vehicles with high degree of driving automation. For commercial SL applications, two desirable elements may include:
Increased SL data rate; and/or
Support of new carrier frequencies for SL

To achieve these elements, one objective in release-18 (Rel.18) is to extend SL operation in the unlicensed spectrum, which may be referred to as NR-U SL in the remainder of this disclosure. However, it may be noted that, to allow fair usage of the spectrum and fair coexistence among different technologies, different regional regulatory requirements are imposed worldwide. Thus, to enable a solution for all regions complying with the strictest regulation from the European Telecommunications Standards Institute (ETSI) Broadband Radio Access Network (BRAN) committee published in European Standard (EN) 301 893 may be sufficient.

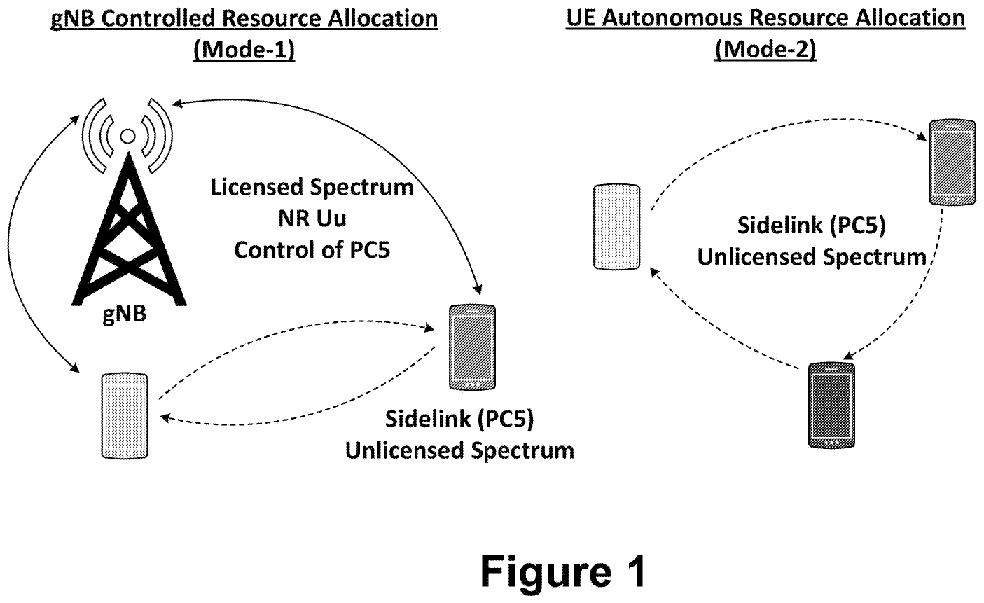

With that said, to enable a SL communication system in the unlicensed band, the considerations of SL communication systems may need to be combined with the regulator requirements necessary for the operation in the unlicensed bands. In particular, it may be noted that NR SL may be operated through one of the following two example modes of operation: 1) mode-1, where a base stations such as a gNodeB (gNB) schedules the SL transmission resource(s) to be used by the user equipment (UE), and Uu operation is limited to licensed spectrum only; 2) mode-2, where a UE determines (i.e, gNB does not schedule) the SL transmission resource(s) within SL resources which are configured by the gNB/network or pre-configured. FIG. 1 illustrates examples of the two modes of operation.

In this context, there are several specific challenges to enable NR-U SL. In particular, one of the challenges is that, when operating in the frequency range 1 (FR-1) unlicensed band, a listen before talk (LBT) procedure may need to be performed to acquire the medium before a transmission can occur. It will be noted that, as used herein, FR-1 may refer to frequency bandwidths of less than or equal to approximately 6 gigahertz (GHz). In other embodiments, FR-1 may be considered to refer to frequency bandwidths of less than or equal to approximately 7 GHz.

When a system operates in the FR-1 unlicensed band in dynamic channel access mode, a device may be mandated to acquire a channel occupancy time (COT) via a type 1 LBT procedure, which may be characterized by a random backoff drawn within a variable contention window, whose size depends on the channel access priority class (CAPC) required by the network to satisfy a given qualify of service (QoS) which is indicated via a QCI (QoS Class Identifier), and whose relationship with the CAPC may be provided in accordance with the examples of Table I.

TABLE I
Example Mapping between Channel
Access Priority Classes and QCI

| Channel Access | QCI |
|---|---|
| 1 p | 1, 3, 5, 65, 66, 69, |
| 2 | 2, 7 |
| 3 | 4, 6, 8, 9 |
| 4 | — |

Furthermore, in Release 14 (Rel.14), the example LBT CAPCs, LBT parameters, and maximum channel occupancy time (MCOT) values summarized in Table II may be used to relate these factors together in the uplink (UL). As used in Table II, CWmin may refer to a minimum contention window size, and CWmax may refer to a maximum contention window size.

TABLE II
Example LBT parameters and MCOT values for UL

| LBT | | | | | |
|---|---|---|---|---|---|
| priority | | | | | |
| class | n | CWmin | CWmax | MCOT | Set of CW sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms (see note | {15, 31, 63, 127, |
| | | | | 1) or 10 ms | 255, 511, 1023} |
| | | | | (see note 2) | |
| 4 | 7 | 15 | 1023 | 6 ms (see note | {15, 31, 63, 127, |
| | | | | 1) or 10 ms | 255, 511, 1023} |
| | | | | (see note 2) | |

(NOTE 1):
The MCOT of 6 ms may be increased to 8 ms by inserting one or more gaps. The minimum duration of a pause shall be 100 μs. The maximum duration (Channel Occupancy) before including any such gap shall be 6 ms. The gap duration is not included in the channel occupancy time.
(NOTE 2):
If the absence of any other technology sharing the carrier can be guaranteed on a long term basis (e.g. by level of regulation), the maximum channel occupancy time (MCOT) for LBT priority classes 3 and 4 is for 10 ms, otherwise, the MCOT for LBT priority classes 3 and 4 is 6 ms as in note 1.

When type 1 LBT is used, the contention windows size (CWS) may be required to be adapted/changed over time to reflect the current channel conditions, contention, and traffic within the channel access procedure. In particular, for both licensed assisted access (LAA) and NR-U, this process of adaptation may be based on the hybrid automatic repeat request (HARQ)-acknowledgment (ACK) feedback, and the adjustment may be done for the UL per UE per each CAPC based on the HARQ feedback received from a gNB.

For Rel.18 NR SL-U, type 1 LBT type may be still used for dynamic channel access mode when initiating a COT, but the HARQ feedback information may no longer be received from a gNB, but from other UEs in case of unicast transmission. However, for broadcast transmissions no feedback information may be provided. Due to these differences, the legacy CWS adjustment mechanism defined in prior releases may not be applied as-is to NR-U SL, and a new CWS adjustment mechanism may be used. Embodiments herein relate to example design options for the CWS adjustment mechanism.

Another aspect to consider for Rel.18 NR-U SL is that the ETSI BRAN may impose that the LBT measurements be performed over one or more chunks of bandwidth that are equivalent to 20 megahertz (MHz), regardless of whether the system will be operating in dynamic or semi-static channel access mode. However, SL may be designed to operate in sub-channels that are not necessarily 20 MHz wide. While this requirement must be met for regulatory compliance in Europe and European Conference of Postal and Telecommunications Administrations (CEPT) regions, such requirements may not be mandatory elsewhere. Therefore, embodiments herein may further relate to how the LBT bandwidth (BW) must be defined in NR-U SL, and its implication in the EDT calculation that is used by the UE to infer and assess whether a channel is idle or occupied during an LBT procedure.

### Adaptation Mechanism for the Contention Window Size

As discussed previously, when type 1 LBT is performed by a UE to acquire a COT, based on the NR-U design the related CWS may be adjusted per UE per each CAPC based on the HARQ feedback received from a gNB. In particular, the adjustment may be based on the information received within a specific instance of time defined reference time, which corresponds to any bursts occurring from the beginning of the channel occupancy until one or more of the following example conditions (or, in other embodiments, some other condition) is satisfied:
the end of the first slot where at least one unicast PUSCH is transmitted; or
the end of the first transmission burst that contains a unicast PUSCH, whichever occurs earlier.

In particular, the NR-U procedure may operate as follows:
1) For every priority class pϵ{1,2,3,4}, set CWₚ=CW_{min,p};
2) If HARQ-ACK feedback is available after the last update of CWₚ, go to element 3. Otherwise, if the UE transmission after type 1 LBT does not include a retransmission or is transmitted within a duration T_{w} from the end of the reference duration corresponding to the earliest UL channel occupancy after the last update of CWₚ, go to element 5; otherwise go to element 4.
3) The HARQ-ACK feedback(s) corresponding to PUSCH(s) in the reference duration for the latest UL channel occupancy for which HARQ-ACK feedback is available is used as follows:

If at least one HARQ-ACK feedback is ‘ACK’ for PUSCH(s) with TB-based feedback, where the term “TB” may refer to a transport block, or at least 10% of HARQ-ACK feedbacks are ‘ACK’ for PUSCH CBGs transmitted at least partially on the channel with code block group (CBG) based feedback, go to element 1; otherwise go to element 4.
4) Increase CWₚ for every priority class pϵ{1,2,3,4} to the next higher allowed value;
5) For every priority class pϵ{1,2,3,4}, maintain CWₚ as it is; go to element 2.

It will be noted that, with respect to the above depicted process, T_{w}=max(T_{A}, T_{B}+1 millisecond (ms) where T_{B} refers to the duration of the transmission burst from the start of the reference duration in ms and T_{A}=5 ms if the absence of any other technology sharing the channel cannot be guaranteed on a long-term basis (e.g. by level of regulation), and T_{A}=10 ms otherwise.

In one embodiment, the CWS is adjusted per UE per each CAPC following one of the procedures described along this disclosure. In another option, the CWS is adjusted per UE over all CAPC following one of the procedures described along this disclosure.

In one embodiment, a value related to “reference time” may not be used for NR-U SL. As for the CWS adjustment:
For unicast transmissions for every attempt to send a specific TB (which could be starting from the first transmissions or the first retransmission), the current size of the contention window will be increased from its initial value (CWₘᵢₙ) until it reaches a maximum value (CWₘₐₓ). If the CWₘₐₓ is reached, this can be consecutively used only for K times, and after that the CW is reset to its initial value (CWₘᵢₙ) only for the priority class p for which CW is CWₘₐₓ or for all priority classes as long for one of them CW is CWₘₐₓ. In one option K is fixed or can be selected up to UE's implementation from a set of values which has an example can be {1, 2, . . . 8}. However, after a successful transmission (e.g., acknowledgement (ACK) is received) and/or when the TB has to be discarded because the maximum number of channel access attempts is reached, the CW will be set to its initial value again (CWₘᵢₙ).
For broadcast or groupcast transmissions or unicast and groupcast transmission with SL feedback disabled, the backoff procedure may only be invoked during the sensing, and the CW may always be set to its minimum value, CWₘᵢₙ, and it may not be doubled.

In one embodiment, a variable related to reference time may not be used for NR-U SL. As for the CWS adjustment, one or more of the following example elements may be used:
For every priority class pϵ{1,2,3,4}, set CWₚ=CW_{min,p} or for all priority classes set CW=CWₘᵢₙ.
In one option, the CW is increased anytime a negative acknowledgement (e.g., a “NACK”) is received corresponding to an UL burst containing at least a SL unicast UL transmission for a TB, of all TBs transmissions or X % of the TB transmitted within that SL UL burst. The CW is increased until it reaches a maximum value (CWₘₐₓ).
In another option, the CW is reset to its minimum value (CWₘᵢₙ), anytime an ‘ACK’ is received corresponding to an UL burst containing at least a SL unicast UL transmission for a TB, of all TB transmissions or Y % of the TBs transmitted within that SL UL burst. Otherwise, the CW is increased until it reaches a maximum value (CWₘₐₓ). Y could be fixed or (pre-)configured.
In case, the SL UL burst is composed by broadcast UL transmissions, or, or groupcast UL transmission or unicast and groupcast transmission with SL feedback disabled, additionally in one option the whole UL burst may be retransmitted within a duration T_{w} from the end of the earliest SL UL channel occupancy for that UE after the last update of the CW, the CW is left unchanged, otherwise the CW will be increased until it reaches a maximum value (CWₘₐₓ).

If the CWₘₐₓ is reached, this may be consecutively used only for K times, and after that the CW is reset to its initial value (CWₘᵢₙ) only for the priority class p for which CW is CWₘₐₓ or for all priority classes as long for one of them CW is CWₘₐₓ. In one option K is fixed or can be selected up to UE's implementation from a set of values which has an example can be {1, 2, . . . 8}.

In one embodiment of this option, T_{w}=T_{A} where T_{A} has a fixed value and as an example T_{A}=5 ms if the absence of any other technology sharing the channel cannot be guaranteed on a long-term basis (e.g. by level of regulation), and T_{A}=10 ms otherwise.

In one embodiment, the concept of SL reference time duration or SL reference burst is introduced, and may be defined in accordance with one or more of the following example options (and/or some other option or factor):
Option 1: the beginning of the channel occupancy until the end of the first SL slot where at least one unicast PSSCH and/or groupcast PSSCH with HARQ-ACK enabled is transmitted;
Option 2: the beginning of the channel occupancy until the end of the first SL transmission where at least one unicast PSSCH and/or groupcast PSSCH with HARQ-ACK enabled is transmitted;
Option 3: both are considered and whoever occurs first is applied;
Option 4: the beginning of the channel occupancy until X ms or symbols or slots, where X is fixed or configurable. In one example, X may be fixed to 1 ms.
Option 5: the end of the COT if any prior transmission bursts contain physical sidelink shard channel (PSSCH) transmissions with HARQ-ACK disabled.

As for the CWS adjustment, one or more of the following example actions may occur (and/or some other action):
For every priority class pϵ{1,2,3,4}, set CWₚ=CW_{min,p} or for all priority classes set CW=CWₘᵢₙ.
the CW is increased anytime a NACK corresponding to a transmission occurring within the SL reference burst containing at least a SL unicast UL transmission is received for a TB, of all TB transmissions or X % of the TB transmitted within that SL reference burst. The CW is increased until it reaches a maximum value (CWₘₐₓ).
The CW is reset to its minimum value (CWₘᵢₙ), anytime an ACK corresponding to a transmission occurring within the SL reference burst containing at least a SL unicast UL transmission is received for a TB, of all TB transmissions or Y % of the TB transmitted within that SL reference burst.
In case, the SL reference burst is composed by a broadcast UL transmission, or groupcast UL transmission or unicast and groupcast transmission with SL feedback disabled, or additionally in one option this is retransmitted within a duration T_{w} from the end of the SL reference duration corresponding to the earliest SL UL channel occupancy after the last update of the CW, the CW is left unchanged, otherwise the CW will be increased until it reaches a maximum value (CWₘₐₓ).

If the CWₘₐₓ is reached, this can be consecutively used only for K times, and after that the CW is reset to its initial value (CWₘᵢₙ) only for the priority class p for which CW is CWₘₐₓ or for all priority classes as long for one of them CW is CWₘₐₓ. In one option K is fixed or can be selected up to UE's implementation from a set of values which has an example can be {1, 2, . . . 8}.

In one embodiment of this option, T_{w}=max(T_{A}, T_{B}+1 ms) where T_{B} is the duration of the transmission burst from the start of the reference duration in ms and T_{A} has a fixed value and as an example T_{A}=5 ms if the absence of any other technology sharing the channel cannot be guaranteed on a long-term basis (e.g. by level of regulation), and T_{A}=10 ms, otherwise.

In one embodiment, the concept of SL reference time or SL reference burst is introduced, and this is defined as one or more of the following example options (and/or some other additional or alternative factor):
Option 1: the beginning of the channel occupancy until the end of the first SL slot where at least one unicast PSSCH and/or groupcast with HARQ-ACK enabled is transmitted;
Option 2: the beginning of the channel occupancy until the end of the first SL transmission where at least one unicast PSSCH and/or groupcast with HARQ-ACK enabled is transmitted;
Option 3: both are considered and whoever occurs first is applied;
Option 4: the beginning of the channel occupancy until X ms or symbols or slots, where X is fixed or configurable. In one example, X could be fixed to 1 ms.
Option 5: the end of the COT if any prior transmission bursts contain PSSCH transmissions with HARQ-ACK disabled.

As for the CWS adjustment, the following example process may be used:
1) For every priority class pϵ{1,2,3,4}, set CWₚ=CW_{min,p} or for all priority classes set CW=CWₘᵢₙ.
2) If physical sidelink feed back channel(s) (PSFCH(s)) or generally HARQ feedback is (are) available for the SL reference burst, go to element 3. If the UE transmission after type 1 LBT does not include a retransmission (e.g., the UL burst is composed by broadcasting transmissions only, or groupcast UL transmission, or unicast and groupcast transmission with SL feedback disabled), go to element 5.
3) If at least one HARQ-ACK feedback is ‘ACK’ or all HARQ-ACK feedbacks are ‘ACK’ or X % of all HARQ-ACK feedbacks are ‘ACK’ for PSSCH(s), go to element 1; otherwise go to element 4.
4) Increase CWₚ for every priority class pϵ{1,2,3,4} to the next higher allowed value or increase CW for all priority classes;
5) For every priority class pϵ{1,2,3,4}, maintain CWₚ as it is or maintain CW for all priority classes; go to element 2.

If the CWₘₐₓ is reached, this can be consecutively used only for K times, and after that the CW is reset to its initial value (CWₘᵢₙ) only for the priority class p for which CW is CWₘₐₓ or for all priority classes as long for one of them CW is CWₘₐₓ. In one option K is fixed or can be selected up to UE's implementation from a set of values which as an example can be {1, 2, . . . 8}.

In one embodiment, the concept of SL reference time or SL reference burst is introduced, and this is defined as one or more of the following example options (and/or some other additional or alternative option):
Option 1: the beginning of the channel occupancy until the end of the first SL slot where at least one unicast PSSCH and/or groupcast option with HARQ-ACK enabled is transmitted;
Option 2: the beginning of the channel occupancy until the end of the first SL transmission where at least one unicast PSSCH and/or groupcast option with HARQ-ACK enabled is transmitted;
Option 3: both are considered and whoever occurs first is applied;
Option 4: the beginning of the channel occupancy until X ms or symbols or slots, where X is fixed or configurable. In one example, X could be fixed to 1 ms.
Option 5: the end of the COT if any prior transmission bursts contain PSSCH transmissions with HARQ-ACK disabled.

As for the CWS adjustment, the following example process may be performed
1) For every priority class pϵ{1,2,3,4}, set CWₚ=CW_{min,p} or for all priority classes set CW=CWₘᵢₙ.
2) If PSFCH(s) or generally HARQ feedback is (are) available after the last update of CWₚ, go to step 3. Otherwise, if the UE transmission after type 1 LBT does not include a retransmission or is transmitted within a duration T_{w} from the end of the SL reference duration corresponding to the earliest SL UL channel occupancy after the last update of CWₚ or CW, go to element 5; otherwise go to element 4.
3) The HARQ-ACK feedback(s) corresponding to PSSCH(s) in the SL reference duration for the latest SL UL channel occupancy for which HARQ-ACK feedback is available is used as follows:

If at least one HARQ-ACK feedback is ‘ACK’ or all HARQ-ACK feedbacks are ‘ACK’ or X % of all HARQ-ACK feedbacks are ‘ACK’ for PSSCH(s), go to element 1; otherwise go to element 4.
4) Increase CWₚ for every priority class pϵ{1,2,3,4} to the next higher allowed value or increase CW for all priority classes;
5) For every priority class pϵ{1,2,3,4}, maintain CWₚ as it is or maintain CW for all priority classes; go to element 2.

If the CWₘₐₓ is reached, this may be consecutively used only for K times, and after that the CW is reset to its initial value (CWₘᵢₙ) only for the priority class p for which CW is CWₘₐₓ or for all priority classes as long for one of them CW is CWₘₐₓ. In one option K is fixed or can be selected up to UE's implementation from a set of values which as an example can be {1, 2, . . . 8}.

In one embodiment of this option, T_{w}=max(T_{A}, T_{B}+1 ms) where T_{B} is the duration of the transmission burst from the start of the reference duration in ms and T_{A} has a fixed value and as an example T_{A}=5 ms if the absence of any other technology sharing the channel cannot be guaranteed on a long-term basis (e.g. by level of regulation), and T_{A}=10 ms, otherwise.

In one embodiment, for groupcast option 1 transmissions NACK-based feedback may not be supported when operating in unlicensed spectrum for dynamic channel access mode or when the cg-RetransmissionTimer is enabled for semi-static channel access mode. In one embodiment, for groupcast option 1 transmissions NACK-based feedback is supported when operating in unlicensed spectrum and for semi-static channel access mode when the cg-RetransmissionTimer is not enabled.

In one embodiment, for groupcast option 1 transmissions ACK-based feedback is supported, instead of NACK-only-based feedback when operating in unlicensed spectrum regardless of whether operating in semi-static or dynamic channel access mode. In one embodiment, for groupcast option 1 transmissions neither ACK-based or NACK-only-based feedback is supported when operating in unlicensed spectrum for dynamic channel access mode or when the cg-RetransmissionTimer is enabled for semi-static channel access mode. In one embodiment, ACK-based feedback is only supported for groupcast communication option 1 when operating in unlicensed spectrum and for semi-static channel access mode when the cg-RetransmissionTimer is not enabled.

In one embodiment, for groupcast option 1 transmissions if an ACK-based feedback is adopted, if a UE receives a mix of unicast and groupcast option 1 feedback related to the reference SL duration, it will update the CWS according to one of the rules and mechanisms described along this disclosure.

In one embodiment, groupcast option 1 transmissions may not be supported for unlicensed operation.

In one embodiment, for groupcast option 2 transmissions, a UE may report a ‘ACK’ if all expected PSFCH resources carry ACK, and NACK is reported if at least one PSFCH carries NACK or if no PSFCH is detected. Furthermore, if a UE receives a mix of unicast and groupcast option 1/2 feedbacks related to the reference SL duration, it will update the CWS according to one of the rules and mechanisms described along this disclosure by also accounting for the groupcast option 2 feedbacks based on the rule above on how the UE reports ‘ACK’ and ‘NACK’.

In one embodiment, for groupcast option 2 transmissions, a UE may report a ‘ACK’ if at least 10% of the expected PSFCH resources carry ‘ACK’, and ‘NACK’ otherwise. Furthermore, if a UE receives a mix of unicast and groupcast option 1/2 feedbacks related to the reference SL duration, it will update the CWS according to one of the rules and mechanisms described along this disclosure by also accounting for the groupcast option 2 feedbacks based on the rule above on how the UE reports ‘ACK’ and ‘NACK’.

In one embodiment, for groupcast option 2 transmissions, a UE may report a ‘ACK’ if at least X % of the expected PSFCH resources carry ‘ACK’, and ‘NACK’ otherwise, where X may be fixed or (pre-)configured. Furthermore, if a UE receives a mix of unicast and groupcast option 1/2 feedbacks related to the reference SL duration, it will update the CWS according to one of the rules and mechanisms described along this disclosure by also accounting for the groupcast option 2 feedbacks based on the rule above on how the UE reports ‘ACK’ and ‘NACK’.

In one embodiment, if a UE receives a mix of unicast and/or groupcast option 1 (with ACK-only based feedback) and/or groupcast option 2 feedbacks related to transmission occurred within the reference SL duration, despite of how a UE may actually report a ‘ACK’ or ‘NACK’ for groupcast option 2 transmissions, it may update the CWS according to the following example rule (and/or some other rule or algorithm):
If at least a ‘ACK’ is received related to unicast or groupcast option 1 PSSCH transmission transmitted within the reference SL duration, then set CWₚ=CW_{min, p}
If no ‘ACK’ is received related to any unicast or groupcast option 1 PSSCH transmitted within the reference SL duration, but at least X % of the feedback for groupcast option 2 are ‘ACK’, then then set CWₚ=CW_{min,p}, where X could be either fixed (e.g., 10%) or (pre-)configured.
Otherwise increase CWₚ to the next higher value or reset CWₚ to its minimal value according to some of)) rules provided along this disclosure.

In one embodiment, while for the case a reference burst contains at least a unicast and groupcast transmissions with HARQ-ACK enabled, one of the rules and mechanisms described along this disclosure can be used. However, when the reference burst contains solely unicast and groupcast transmissions with HARQ-ACK disabled, the CWS may be:
Increased if within the reference burst contains all PSSCH retransmissions; and/or
CWₚ=CW_{min,p} if the reference burst contains at least a new transmission of a TB.

Notice that the various example embodiments listed above may not be considered to be mutually exclusive, and one or more of them may apply or be performed together, whether sequentially or in parallel.

### Bandwidth for LBT Measurements

As discussed above, the ETSI BRAN may impose that the LBT measurements be performed over chunks of bandwidth equivalent to 20 MHz, regardless of whether the system will be operating in dynamic or semi-static channel access mode. By contrast, 3GPP SL may be designed to operate in sub-channels that are not necessarily 20 MHz wide. While this 20 MHz requirement must be met for regulatory compliance in Europe and CEPT regions, such a requirement may not be mandatory elsewhere. Therefore, in one embodiment, one or more of the following example LBT measurement bandwidth options (and/or some other option) may be considered for SL communication:
Option 1A (per BWP): The LBT measurement is performed over a configurable SL BW (e.g., per SL BWP), and the LBT measurement bandwidth and its allocation in frequency can be configured system-wide (e.g., start/end physical resource blocks (PRBs) cover the LBT measurement bandwidth unit of 20 MHz as intended by the ETSI BRAN).
Option 1B (per resource pool): The LBT measurement is performed over a configured SL resource pool bandwidth and its allocation in frequency (per SL resource pool)
   This option can be beneficial if multiple SL resource pools with different bandwidths and frequency allocation are supported for NR SL communication in unlicensed bands.
Option 1C (per transmission bandwidth): The LBT measurement is performed over the transmit (TX) UE frequency allocation (i.e., per bandwidth of SL transmission)
   This option can be beneficial if sidelink transmissions from different UEs can be multiplexed in frequency (e.g., inside of sidelink resource pool or carrier)
Option 1D (per subchannel): The LBT measurement is performed over a SL subchannel of the resource pool (i.e., per SL subchannel of SL resource pool)
   This option may be used for more intelligent operation and resource selection if sidelink transmissions from different UEs can be multiplexed in frequency (e.g., inside of sidelink resource pool or carrier) or sub-channelization is supported for communication in unlicensed spectrum
Option 1E (per channel/component carrier (CC) bandwidth): The LBT measurement is performed per channel BW or CC BW.
   This option is the baseline for communication in unlicensed spectrum where energy is measured over wideband

In one embodiment, one or more of the above options could be enabled based on regional regulations, and for example through a dedicated cell specific radio resource control (RRC) signaling (or some other higher-layer signaling) and/or resource pool configuration. As an example the following combinations can be considered: 1) combinations of Option 1A/1E with Option 1C/1D, or 2) combinations of Option 1B with Option 1C/1D.

### Energy Detection Threshold

During an LBT procedure, associated energy measurements may be performed in specific energy measurement intervals called observation windows. Within these observation windows, the measured energy may be compared with an EDT in order to determine whether a channel is idle or busy. If the measured energy is above the EDT, the observation window is considered occupied, otherwise it is considered idle.

In NR-U, the EDT in uplink X_{Thresh_max} may be calculated as follows:

```
If the UE is configured with higher layer parameter maxEnergyDetectionThreshold-r14 or
maxEnergyDetectionThreshold-r16,
  X_{Thres}_max is set equal to the value signaled by the higher layer parameter;
Otherwise
  if the UE is configured with higher layer parameter
  energyDetectionThresholdOffset-r14 or energyDetectionThresholdOffset-r16
    X_{Thresh}_max is set by adjusting X_{Thresh}_max′ according to the offset
    value signalled by the higher layer parameter;
  Otherwise X_{Thresh}_max = X_{Thresh}_max′ , where
  If the higher layer parameter absenceOfAnyOtherTechnology-r14 or
  absenceOfAnyOther Technology-r16 is provided
${X}_{Thresh \_ max}^{′} = min \{ \begin{matrix}{T}_{max} + 10 dB \\ {X}_{r}\end{matrix} \} where$
Xᵣ is maximum energy detection threshold defined by regulatory requirements in dBm
when such requirements are defined (Case 1), otherwise (Case 2) Xᵣ = Tₘₐₓ + 10 dB
  otherwise
${X}_{Thresh \_ max}^{′} = max \{ \begin{matrix}- 72 + 10 \cdot log 10 ( BWMHz / 20 MHz ) dBm , \\ min \{ \begin{matrix}{T}_{max} , \\ {T}_{max} - {T}_{A} + ( {P}_{H} + 10 \cdot log 10 ( BWMHz / 20 MHz ) - {P}_{TX}\end{matrix}\end{matrix} \}$
where
T_{A} = 10 dB;
P_{H} = 23 dBm;
P_{TX} is the set to the value of PCMAX_H,c (UE’s output power)
${T}_{max} ( dBm ) = 10 \cdot log 10 ( 3.16228 \cdot {10}^{- 8} ( mW / MHz ) \cdot BWMHz ( MHz ) ) = - 75 ( \frac{dBm}{MHz} ) ;$
```

BW MHz is the single channel bandwidth in MHz.

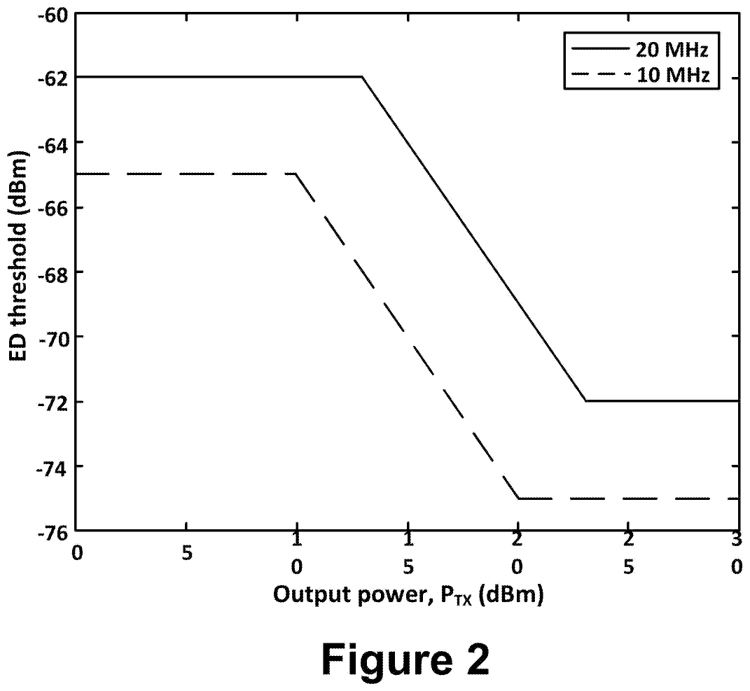

In the above formula, the EDT may be increased based on the difference between the max TX power supported (i.e., 23 decibel-milliwatts (dBm)) and the actual TX power. In addition, the EDT is lower if the single channel bandwidth is lower than 20 MHz (i.e., lower threshold for lower bandwidths), and illustrated in FIG. 2.

In one embodiment, the formula provided above may be adopted for one or multiple of the following example SL transmissions (although, in other embodiments, the above formula may be adopted for or related to additional SL transmissions either now-known or identified in the future):
PSSCH/physical sidelink control channel (PSCCH)
Physical sidelink broadcast channel (PSBCH)
Sidelink primary synchronization signal (S-PSS)
Sidelink secondary synchronization signal (S-SSS)
PSFCH

To account for a specific channel access type used for PSFCH or a standalone PSCCH transmission, and for instance in case PSFCH is qualified as short control signaling and type 2A could be applied to this type of transmission outside a COT in one embodiment, the EDT calculation may be modified based on one or more of the following example options (and/or some other additional or alternative option or modification factor):

Option 1: (pre-defined and fixed EDT value in specification for PSFCH transmission)
If PSFCH or a standalone PSCCH is qualified as a short control signaling and type 2A is applied to it before its transmission, similarly as for the discovery reference signal (DRS) in Rel.16, the T_{A}=5 dB can be taken for LBT energy measurements targeting PSFCH or a standalone PSCCH transmission.

Option 2: (pre-configured EDT value for PSFCH or a standalone PSCCH transmission)
The value of T_{A}=X dB for PSFCH or a standalone PSCCH, can be pre-configured with value X, where X could be 15 dB, and the EDT could be relaxed.

Option 3: while the formula provided above is adopted, the value of T_{A} that a UE may use may depend on whether the PSFCH transmission may fall within or outside a COT. For example, if the PSFCH transmission falls within a shared COT, a UE may use T_{A}=5 dB, while if it falls outside a shared COT a UE may use T_{A}=10 dB

Option 4: the formula provided above is adopted and T_{A}=10 dB when UE performs a PSFCH transmission.

In one embodiment, one of the above options may be also applied to S-SSB. In fact, if similar enhancements as in NR-U are applied to S-SSB, and the concept of DRS is formed, then T_{A}=5 dB for the SL equivalent of the DRS.

In one embodiment, if S-SSB is qualified as short control signaling and type 2A could be applied to S-SSB outside a COT, while the legacy EDT threshold calculation formula could be reused, it could be modified based on one or more of the following example options (and/or some other option or factor):
Option 1: for S-SSB T_{A}=5 dB
Option 2: for S-SSB T_{A}=X dB where X can be (pre-)configured per sidelink bandwidth part.
Option 3: for S-SSB the value of T_{A} that a UE may use may depend on whether the S-SSB transmission may fall within or outside a COT. For example, if the S-SSB transmission falls within a shared COT, a UE may use T_{A}=5 dB, while if it falls outside a shared COT a UE may use T_{A}=10 dB
Option 4: for S-SSB T_{A}=10 dB.

In one embodiment, if frequency division multiplexing (FDM)/sub-channelization is used for SL transmissions in unlicensed band one or more of the following example options (and/or some other option or factor) may be adopted:

Option 1: the NR-U SL EDT calculation is reused, and BW MHz (MHz) is equivalent to the bandwidth in MHz of
Option 1A: (BWP bandwidth)
   SL BWP where SL transmission is performed
Option 1B: (resource pool bandwidth)
   Sidelink resource pool BW (i.e., aggregation of the sub-channels used)
Option 1C: (transmission bandwidth)
   Sidelink transmission BW (or effective BW in case of interlaced structure)
Option 1D: (subchannel bandwidth)
   Sidelink subchannel BW of the resource pool where sidelink transmission is expected (or effective subchannel BW in case of interlaced structure)
Option 1E: (channel/CC bandwidth)
   Single channel bandwidth, e.g., 10, 20 MHz or higher in case of multi-channel operation

Option 2: The SL EDT may be calculated as follows:

$${X}_{Thresh \_ max}^{′} = min \{ \begin{matrix}{T}_{max} + 10 dB \\ {X}_{r}\end{matrix} \}$$

Xᵣ is maximum energy detection threshold defined by regulatory requirements in dBm when such requirements are defined, otherwise Xᵣ=Tₘₐₓ+10 dB

Option 3: X_{Thresh_max} is set equal to a value signaled by a higher layer parameter.

In one embodiment, for SL transmissions the P_{TX} is equivalent to the maximum output power for the initiating device. In one embodiment, for SL transmissions the P_{TX} is equivalent to the maximum output power accounting for both initiating and responding device(s), and it is equivalent to the highest among them. In this option, the SL control information (either in stage-1 or stage-2 or both) includes a dedicated field which carries information related to the maximum output power of a UE or its power class.

In one embodiment, for SL transmissions the P_{TX} is adjusted and relaxed if the system operates in band n102 (e.g., frequencies between 5925-6425 MHz) in EU. In this band of operation, the ETSI BRAN committee has imposed a relaxation in terms of how the ED threshold is calculated and also imposes different maximum output power depending on the use case: in fact for Low power indoor (LPI) use the maximum effective isotropic radiated power (EIRP) could be 23 dBm, but for Very low power (VLP) use the maximum EIRP is set to 14 dBm. In this matter:

In one example, the energy detection threshold may be calculated as below:

$${X}_{Thresh \_ max}^{′} = max \{ \begin{matrix}- 72 + 10 \cdot log 10 ( BWMHz / 20 MHz ) dBm , \\ min \{ \begin{matrix}{T}_{max} , \\ {T}_{max} - {T}_{A} + ( {P}_{H} + 10 \cdot log 10 ( BWMHz / 20 MHz ) - {P}_{TX}^{′} )\end{matrix} \}\end{matrix} \}$$

where P_{TX}′=P_{TX} if SL system does not operate in band n102.
where P_{TX}′=P_{TX}+1 dBm (or P_{TX}′=P_{TX}−1 dBm) if the SL system operates in band n102.

Whether a SL system operates in band n102 or not, may be provided via higher layer signaling through remaining minimum system information (RMSI) or dedicated radio resource control (RRC) signaling. As an alternative or in addition, this indication could be provided as part of the resource pool configuration.

In another example, the energy detection threshold could be calculated as below:

$${X}_{Thresh \_ max}^{′} = max \{ \begin{matrix}- 72 + 10 \cdot log 10 ( BWMHz / 20 MHz ) dBm , \\ min \{ \begin{matrix}{T}_{max} , \\ {T}_{max} - {T}_{A} + ( {P}_{H} + 10 \cdot log 10 ( BWMHz / 20 MHz ) - {P}_{TX}^{′} )\end{matrix} \}\end{matrix} \}$$

where P_{TX}′=P_{TX} and P_{H}=23 dBm if SL system does not operate in band n102.
where P_{TX}′=P_{TX}+1 dBm (or P_{TX}′=P_{TX}−1 dBm) and P_{H}=24 dBm if the SL system operates in band n102.

Whether a SL system operates in band n102 or not, may be provided via higher layer signaling through remaining minimum system information (RMSI) or dedicated radio resource control (RRC) signaling. As an alternative or in addition, this indication could be provided as part of the resource pool configuration.

In another example, the energy detection threshold could be calculated as below:

$${X}_{Thresh \_ max}^{′} = max \{ \begin{matrix}- 72 + 10 \cdot log 10 ( BWMHz / 20 MHz ) dBm , \\ min \{ \begin{matrix}{T}_{max} , \\ {T}_{max} - {T}_{A} + ( {P}_{H} + 10 \cdot log 10 ( BWMHz / 20 MHz ) - {P}_{TX}^{′} )\end{matrix} \}\end{matrix} \}$$

where P_{TX}′=P_{TX} and P_{H}=23 dBm if SL system does not operate in band n102.
where P_{TX}′=P_{TX}+1 dBm (or P_{TX}′=P_{TX}−1 dBm) if the SL system operates in band n102. Furthermore, if the initiating device operates as LPI device, the P_{H}=23 dBm, otherwise if the device operates as VLP device then P_{H}=14 dBm.

Whether a SL system operates in band n102 or not, may be provided via higher layer signaling through remaining minimum system information (RMSI) or dedicated radio resource control (RRC) signaling. As an alternative or in addition, this indication could be provided as part of the resource pool configuration.

In another example, the energy detection threshold could be calculated as below:

$${X}_{Thresh \_ max}^{′} = max \{ \begin{matrix}- 72 + 10 \cdot log 10 ( BWMHz / 20 MHz ) dBm , \\ min \{ \begin{matrix}{T}_{max} , \\ {T}_{max} - {T}_{A} + ( {P}_{H} + 10 \cdot log 10 ( BWMHz / 20 MHz ) - {P}_{TX} )\end{matrix} \}\end{matrix} \}$$

where P_{H}=23 dBm if SL system does not operate in band n102.
where P_{H}=14 dBm if the initiating device operates as VLP device, and where P_{H}=23 dBm if the initiating device operates as LPI device only in case the SL system operate in band n102.

Whether a SL system operates in band n102 or not, may be provided via higher layer signaling through remaining minimum system information (RMSI) or dedicated radio resource control (RRC) signaling. As an alternative or in addition, this indication could be provided as part of the resource pool configuration.

In another example, the energy detection threshold could be calculated as below:

$${X}_{Thresh \_ max}^{′} = max \{ \begin{matrix}- 72 + 10 \cdot log 10 ( BWMHz / 20 MHz ) dBm , \\ min \{ \begin{matrix}{T}_{max} , \\ {T}_{max} - {T}_{A} + ( {P}_{H} + 10 \cdot log 10 ( BWMHz / 20 MHz ) - {P}_{TX}^{′} )\end{matrix} \}\end{matrix} \}$$

where P_{TX}′=P_{TX} and P_{H}=23 dBm if SL system does not operate in band n102.
where P_{TX}′=P_{TX} and P_{H}=24 dBm if the SL system operates in band n102.

Whether a SL system operates in band n102 or not, may be provided via higher layer signaling through remaining minimum system information (RMSI) or dedicated radio resource control (RRC) signaling. As an alternative or in addition, this indication could be provided as part of the resource pool configuration.

Under this example, the EDT threshold is subject to a relaxation of 1 dBm compared to the EDT threshold defined in TS 37.213 as illustrated in FIG. 2.

### Channel Access & LBT Measurement BW

In NR-U design, LBT measurement bandwidth is equal to the single channel/CC bandwidth. However, the NR SL design is more flexible in terms of frequency allocation, and it supports sub-channelization as one of the main design components. For proper coexistence, the relationship of LBT measurement BW, and frequency allocation needs to be discussed for SL communication in unlicensed spectrum. To support, sub-channelization for SL communication in unlicensed spectrum, different conditions may be configured/applied to determine whether the selected frequency allocation and bandwidth can be used for SL transmission.

The use of sub-channel energy measurement and support of FDMed SL transmissions from multiple UEs in one SL channel may depend on deployment scenario and geographical region. In this matter, in one embodiment, whether sub-channelization and which option can be used to determine whether the selected frequency allocation and bandwidth can be used for SL transmission can be controlled by a higher layer parameter, e.g. absenceOfAnyOtherTechnology. In particular, when this higher layer parameter is provided/configured, then sub-channelization and FDM among different UEs is applied for SL transmissions, otherwise the LBT measurement bandwidth should be set to be equal to the channel bandwidth.

In one embodiment, when an higher layer parameter indicates that sub-channelization and FDM among different UEs is applied, the LBT measurement is performed over the individual sub-channels or SL transmission BW used by the UE, rather than performing the LBT measurement over the channel BW (i.e., 20 MHz), and assessment of whether the sub-channel or SL transmission BW is idle or not is based on comparing this measurement with the EDT threshold calculated as in prior section, where the bandwidth in EDT calculation reflects the sub-channel BW or SL transmission BW.

In one embodiment, when the higher layer parameter indicates that sub-channelization and FDM among different UEs is applied, a UE may perform energy measurements with various LBT measurement bandwidth (e.g., see Options 1A-1E for LBT measurement BW from prior section related to LBT measurements) and compare them with corresponding EDTs (e.g., see Options 1A-1E for EDT from prior section related to EDT calculation).

The following examples may be considered without loss of generality to guide UE behavior in terms of transmission bandwidth:
Example 1: Option 1C+Option 1D
   UE can transmit on sub-channel n of transmission bandwidth if any sub-set of the following conditions of the pre-configured energy measurement (EM) compared with corresponding EDT is met
   (EM 1C≤EDT 1C)
   (EM 1D≤EDT 1D)
   (EM 1C≤EDT 1C) & (EM 1D≤EDT 1D)

In one example, a UE may use transmission bandwidth of N sub-channels only if the energy measurement in each sub-channel is below the EDT calculated for each sub-channel or the energy measurement over the SL transmission bandwidth is below the EDT for the SL transmission bandwidth.
Example 2: Option 1D+Option 1E
   UE can transmit on sub-channel n of transmission bandwidth if any sub-set of the following pre-configured conditions for energy measurement (EM) compared with corresponding EDT is met:
   (EM 1E≤EDT 1E)
   (EM 1D≤EDT 1D)
   (EM 1E≤EDT 1E) & (EM 1D≤EDT 1D)

In one example, a UE may transmit on sub-channel n only if the energy measurement in sub-channel n is below the per sub-channel EDT or the energy measurement per channel BW is below the EDT. In another example both conditions can be configured to be met.

### Channel Access for Multi-Carrier Operation

When a SL system operates on a multiple of 20 MHz BW, one or more of the following options could be adopted:
For PSSCH/PSCCH transmissions, when operating in dynamic channel access mode, in order to acquire a COT a UE shall succeed type 1 LBT in all LBT BW over which a SL resource allocation spans.
For PSSCH/PSCCH transmissions, when operating in dynamic channel access mode, in order to acquire a COT a UE shall succeed type 1 LBT in one LBT BW, which is defined to be the primary channel, and type 2A LBT over all other LBT BWs over which a SL resource allocation spans.
For PSSCH/PSCCH transmissions, when operating in dynamic channel access mode, a UE can transmit as long as type 1 LBT succeeds in at least one of the LBT BWs over which a SL resource allocation spans. In this case, SL transmission is only allowed in those LBT BW for which the type 1 LBT succeeded. This also implies independent LBT operation and transmission per 20 MHz BW.
For PSSCH/PSCCH transmissions, when operating in dynamic channel access mode, a UE can transmit as long as type 1 LBT succeeds within the primary channel, and that UE can transmit in any other LBT BW over which a SL resource allocation spans as long as type 2A LBT succeeds in those LBT BWs. In this case, SL transmission is only allowed in those LBT BW for which LBT succeeds. This also implies independent LBT operation and transmission per 20 MHz BW.
When operating in semi-static channel access mode, a UE shall succeed channel access procedure and sensing should indicate that the channel is idle in each channel over which a SL resource allocation spans.
   For S-SSB and/or PSFCH transmissions, when operating in dynamic channel access mode, a UE can transmit as long as type 1 LBT succeeds in at least one of the LBT BWs over which a SL resource allocation spans. In this case, both type A and type B DL multi-carrier procedure as defined in Rel.16 NR-U could be supported, and a SL transmission is only allowed in those LBT BW for which the LBT succeeded (either type 1 or type 2A LBT depending on the criteria used). This also implies independent LBT operation and transmission per 20 MHz BW.
   For S-SSB and/or PSFCH transmissions, when operating in dynamic channel access mode, a UE can transmit as long as type 1 LBT succeeds in all of the LBT BWs over which a SL resource allocation spans, and the procedure would be the same as that used for PSSCH/PSCCH transmissions.

When a SL system operates on a multiple of 20 MHz BW, in one embodiment one or more of the following options could be adopted:
When operating in dynamic channel access mode, both type A and type B DL multi-carrier procedure as defined in Rel.16 NR-U are supported, meaning that transmission is allowed in any LBT BW for which the related LBT succeeds.
When operating in dynamic channel access mode, both type A and type B UL multi-carrier procedure as defined as defined in Rel.16 NR-U are supported, meaning that transmission is allowed only as long as LBT succeeds in every LBT BW.
When operating in dynamic channel access mode, both the Rel.16 NR-U DL multi-carrier procedure and the Rel.16 NR-U UL multi-carrier procedure is supported.
   In one option, the Rel.16 NR-U DL multi-carrier procedure is applied for UEs in RA mode 2, while the UL multi-carrier procedure is applied for UEs in RA mode 1, or vice versa.
   In one option, whether the Rel.16 NR-U DL or Rel.16 NR-U UL multi-carrier procedure would be used, it is up to UE's capability or a UE specific or cell specific (pre-)configuration.
When operating in dynamic channel access mode, both the Rel.16 NR-U DL multi-carrier procedure and the Rel.16 NR-U UL multi-carrier procedure is supported depending on the type of SL transmission. For example, for PSSCH/PSCCH and S-SSB transmissions the Rel.16 NR-U UL multi-carrier procedure is supported, while for PSFCH transmissions the Rel.16 NR-U DL multi-carrier procedure is supported.

As previously noted, it will be understood that various ones of the options/embodiments/examples described herein may not be mutually exclusive, and two or more of the above-described options/embodiments/examples may be jointly adopted or performed, whether sequentially or at least partially concurrently.

### Systems and Implementations

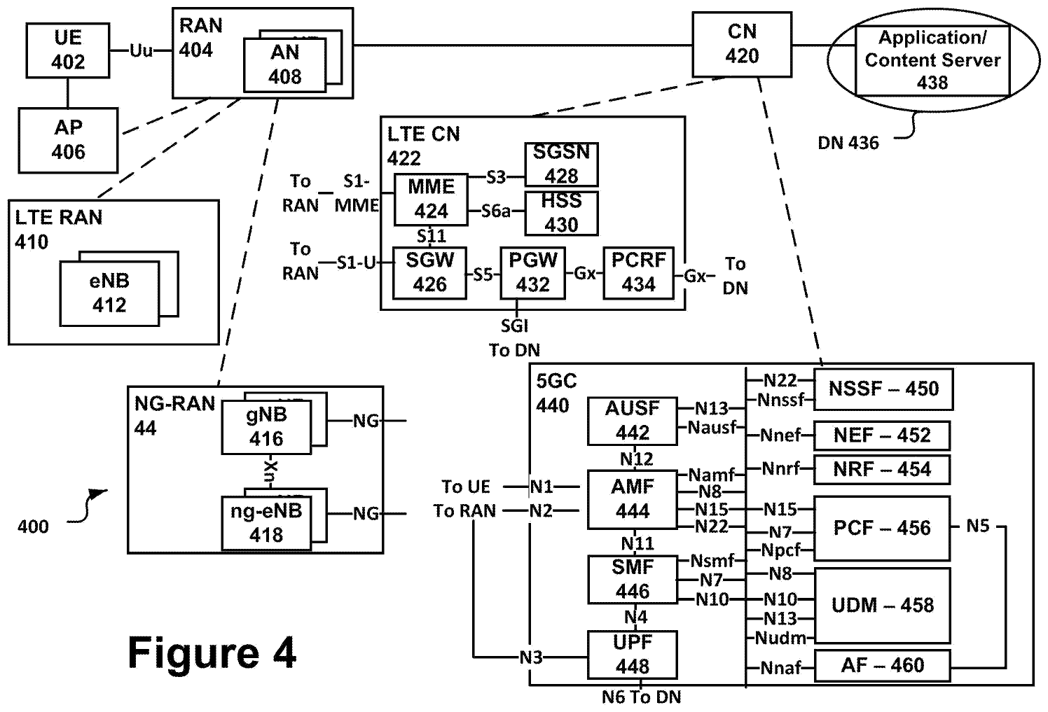

FIGS. 4-7 illustrate various systems, devices, and components that may implement aspects of disclosed embodiments.

FIG. 4 illustrates a network 400 in accordance with various embodiments. The network 400 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 400 may include a UE 402, which may include any mobile or non-mobile computing device designed to communicate with a RAN 404 via an over-the-air connection. The UE 402 may be communicatively coupled with the RAN 404 by a Uu interface. The UE 402 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 400 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 402 may additionally communicate with an AP 406 via an over-the-air connection. The AP 406 may manage a WLAN connection, which may serve to offload some/all network traffic from the RAN 404. The connection between the UE 402 and the AP 406 may be consistent with any IEEE 802.11 protocol, wherein the AP 406 could be a wireless fidelity (Wi-Fi®) router. In some embodiments, the UE 402, RAN 404, and AP 406 may utilize cellular-WLAN aggregation (for example, LWA/LWIP). Cellular-WLAN aggregation may involve the UE 402 being configured by the RAN 404 to utilize both cellular radio resources and WLAN resources.

The RAN 404 may include one or more access nodes, for example, AN 408. AN 408 may terminate air-interface protocols for the UE 402 by providing access stratum protocols including RRC, PDCP, RLC, MAC, and L1 protocols. In this manner, the AN 408 may enable data/voice connectivity between CN 420 and the UE 402. In some embodiments, the AN 408 may be implemented in a discrete device or as one or more software entities running on server computers as part of, for example, a virtual network, which may be referred to as a CRAN or virtual baseband unit pool. The AN 408 be referred to as a BS, gNB, RAN node, eNB, ng-eNB, NodeB, RSU, TRxP, TRP, etc. The AN 408 may be a macrocell base station or a low power base station for providing femtocells, picocells or other like cells having smaller coverage areas, smaller user capacity, or higher bandwidth compared to macrocells.

In embodiments in which the RAN 404 includes a plurality of ANs, they may be coupled with one another via an X2 interface (if the RAN 404 is an LTE RAN) or an Xn interface (if the RAN 404 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 404 may each manage one or more cells, cell groups, component carriers, etc. to provide the UE 402 with an air interface for network access. The UE 402 may be simultaneously connected with a plurality of cells provided by the same or different ANs of the RAN 404. For example, the UE 402 and RAN 404 may use carrier aggregation to allow the UE 402 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 404 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 402 or AN 408 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 404 may be an LTE RAN 410 with eNBs, for example, eNB 412. The LTE RAN 410 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 404 may be an NG-RAN 414 with gNBs, for example, gNB 416, or ng-eNBs, for example, ng-eNB 418. The gNB 416 may connect with 5G-enabled UEs using a 5G NR interface. The gNB 416 may connect with a 5G core through an NG interface, which may include an N2 interface or an N3 interface. The ng-eNB 418 may also connect with the 5G core through an NG interface, but may connect with a UE via an LTE air interface. The gNB 416 and the ng-eNB 418 may connect with each other over an Xn interface.

In some embodiments, the NG interface may be split into two parts, an NG user plane (NG-U) interface, which carries traffic data between the nodes of the NG-RAN 414 and a UPF 448 (e.g., N3 interface), and an NG control plane (NG-C) interface, which is a signaling interface between the nodes of the NG-RAN 414 and an AMF 444 (e.g., N2 interface).

The NG-RAN 414 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 402 can be configured with multiple BWPs where each BWP configuration has a different SCS. When a BWP change is indicated to the UE 402, the SCS of the transmission is changed as well. Another use case example of BWP is related to power saving. In particular, multiple BWPs can be configured for the UE 402 with different amount of frequency resources (for example, PRBs) to support data transmission under different traffic loading scenarios. A BWP containing a smaller number of PRBs can be used for data transmission with small traffic load while allowing power saving at the UE 402 and in some cases at the gNB 416. A BWP containing a larger number of PRBs can be used for scenarios with higher traffic load.

The RAN 404 is communicatively coupled to CN 420 that includes network elements to provide various functions to support data and telecommunications services to customers/subscribers (for example, users of UE 402). The components of the CN 420 may be implemented in one physical node or separate physical nodes. In some embodiments, NFV may be utilized to virtualize any or all of the functions provided by the network elements of the CN 420 onto physical compute/storage resources in servers, switches, etc. A logical instantiation of the CN 420 may be referred to as a network slice, and a logical instantiation of a portion of the CN 420 may be referred to as a network sub-slice.

In some embodiments, the CN 420 may be an LTE CN 422, which may also be referred to as an EPC. The LTE CN 422 may include MME 424, SGW 426, SGSN 428, HSS 430, PGW 432, and PCRF 434 coupled with one another over interfaces (or “reference points”) as shown. Functions of the elements of the LTE CN 422 may be briefly introduced as follows.

The MME 424 may implement mobility management functions to track a current location of the UE 402 to facilitate paging, bearer activation/deactivation, handovers, gateway selection, authentication, etc.

The SGW 426 may terminate an Si interface toward the RAN and route data packets between the RAN and the LTE CN 422. The SGW 426 may be a local mobility anchor point for inter-RAN node handovers and also may provide an anchor for inter-3GPP mobility. Other responsibilities may include lawful intercept, charging, and some policy enforcement.

The SGSN 428 may track a location of the UE 402 and perform security functions and access control. In addition, the SGSN 428 may perform inter-EPC node signaling for mobility between different RAT networks; PDN and S-GW selection as specified by MME 424; MME selection for handovers; etc. The S3 reference point between the MME 424 and the SGSN 428 may enable user and bearer information exchange for inter-3GPP access network mobility in idle/active states.

The HSS 430 may include a database for network users, including subscription-related information to support the network entities' handling of communication sessions. The HSS 430 can provide support for routing/roaming, authentication, authorization, naming/addressing resolution, location dependencies, etc. An S6a reference point between the HSS 430 and the MME 424 may enable transfer of subscription and authentication data for authenticating/authorizing user access to the LTE CN 420.

The PGW 432 may terminate an SGi interface toward a data network (DN) 436 that may include an application/content server 438. The PGW 432 may route data packets between the LTE CN 422 and the data network 436. The PGW 432 may be coupled with the SGW 426 by an S5 reference point to facilitate user plane tunneling and tunnel management. The PGW 432 may further include a node for policy enforcement and charging data collection (for example, PCEF). Additionally, the SGi reference point between the PGW 432 and the data network 436 may be an operator external public, a private PDN, or an intra-operator packet data network, for example, for provision of IMS services. The PGW 432 may be coupled with a PCRF 434 via a Gx reference point.

The PCRF 434 is the policy and charging control element of the LTE CN 422. The PCRF 434 may be communicatively coupled to the app/content server 438 to determine appropriate QoS and charging parameters for service flows. The PCRF 432 may provision associated rules into a PCEF (via Gx reference point) with appropriate TFT and QCI.

In some embodiments, the CN 420 may be a 5GC 440. The 5GC 440 may include an AUSF 442, AMF 444, SMF 446, UPF 448, NSSF 450, NEF 452, NRF 454, PCF 456, UDM 458, and AF 460 coupled with one another over interfaces (or “reference points”) as shown. Functions of the elements of the 5GC 440 may be briefly introduced as follows.

The AUSF 442 may store data for authentication of UE 402 and handle authentication-related functionality. The AUSF 442 may facilitate a common authentication framework for various access types. In addition to communicating with other elements of the 5GC 440 over reference points as shown, the AUSF 442 may exhibit an Nausf service-based interface.

The AMF 444 may allow other functions of the 5GC 440 to communicate with the UE 402 and the RAN 404 and to subscribe to notifications about mobility events with respect to the UE 402. The AMF 444 may be responsible for registration management (for example, for registering UE 402), connection management, reachability management, mobility management, lawful interception of AMF-related events, and access authentication and authorization. The AMF 444 may provide transport for SM messages between the UE 402 and the SMF 446, and act as a transparent proxy for routing SM messages. AMF 444 may also provide transport for SMS messages between UE 402 and an SMSF. AMF 444 may interact with the AUSF 442 and the ULE 402 to perform various security anchor and context management functions. Furthermore, AMF 444 may be a termination point of a RAN CP interface, which may include or be an N2 reference point between the RAN 404 and the AMF 444; and the AMF 444 may be a termination point of NAS (N1) signaling, and perform NAS ciphering and integrity protection. AMF 444 may also support NAS signaling with the UE 402 over an N3 IWF interface.

The SMF 446 may be responsible for SM (for example, session establishment, tunnel management between UPF 448 and AN 408); UE IP address allocation and management (including optional authorization); selection and control of UP function; configuring traffic steering at UPF 448 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 444 over N2 to AN 408; and determining SSC mode of a session. SM may refer to management of a PDU session, and a PDU session or “session” may refer to a PDU connectivity service that provides or enables the exchange of PDUs between the UE 402 and the data network 436.

The UPF 448 may act as an anchor point for intra-RAT and inter-RAT mobility, an external PDU session point of interconnect to data network 436, and a branching point to support multi-homed PDU session. The UPF 448 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 448 may include an uplink classifier to support routing traffic flows to a data network.

The NSSF 450 may select a set of network slice instances serving the UE 402. The NSSF 450 may also determine allowed NSSAI and the mapping to the subscribed S-NSSAIs, if needed. The NSSF 450 may also determine the AMF set to be used to serve the UE 402, or a list of candidate AMFs based on a suitable configuration and possibly by querying the NRF 454. The selection of a set of network slice instances for the UE 402 may be triggered by the AMF 444 with which the UE 402 is registered by interacting with the NSSF 450, which may lead to a change of AMF. The NSSF 450 may interact with the AMF 444 via an N22 reference point; and may communicate with another NSSF in a visited network via an N31 reference point (not shown). Additionally, the NSSF 450 may exhibit an Nnssf service-based interface.

The NEF 452 may securely expose services and capabilities provided by 3GPP network functions for third party, internal exposure/re-exposure, AFs (e.g., AF 460), edge computing or fog computing systems, etc. In such embodiments, the NEF 452 may authenticate, authorize, or throttle the AFs. NEF 452 may also translate information exchanged with the AF 460 and information exchanged with internal network functions. For example, the NEF 452 may translate between an AF-Service-Identifier and an internal 5GC information. NEF 452 may also receive information from other NFs based on exposed capabilities of other NFs. This information may be stored at the NEF 452 as structured data, or at a data storage NF using standardized interfaces. The stored information can then be re-exposed by the NEF 452 to other NFs and AFs, or used for other purposes such as analytics. Additionally, the NEF 452 may exhibit an Nnef service-based interface.

The NRF 454 may support service discovery functions, receive NF discovery requests from NF instances, and provide the information of the discovered NF instances to the NF instances. NRF 454 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 454 may exhibit the Nnrf service-based interface.

The PCF 456 may provide policy rules to control plane functions to enforce them, and may also support unified policy framework to govern network behavior. The PCF 456 may also implement a front end to access subscription information relevant for policy decisions in a UDR of the UDM 458. In addition to communicating with functions over reference points as shown, the PCF 456 exhibit an Npcf service-based interface.

The UDM 458 may handle subscription-related information to support the network entities' handling of communication sessions, and may store subscription data of UE 402. For example, subscription data may be communicated via an N8 reference point between the UDM 458 and the AMF 444. The UDM 458 may include two parts, an application front end and a UDR. The UDR may store subscription data and policy data for the UDM 458 and the PCF 456, and/or structured data for exposure and application data (including PFDs for application detection, application request information for multiple UEs 402) for the NEF 452. The Nudr service-based interface may be exhibited by the UDR 221 to allow the UDM 458, PCF 456, and NEF 452 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 458 may exhibit the Nudm service-based interface.

The AF 460 may provide application influence on traffic routing, provide access to NEF, and interact with the policy framework for policy control.

In some embodiments, the 5GC 440 may enable edge computing by selecting operator/3^{rd} party services to be geographically close to a point that the UE 402 is attached to the network. This may reduce latency and load on the network. To provide edge-computing implementations, the 5GC 440 may select a UPF 448 close to the UE 402 and execute traffic steering from the UPF 448 to data network 436 via the N6 interface. This may be based on the UE subscription data, UE location, and information provided by the AF 460. In this way, the AF 460 may influence UPF (re)selection and traffic routing. Based on operator deployment, when AF 460 is considered to be a trusted entity, the network operator may permit AF 460 to interact directly with relevant NFs. Additionally, the AF 460 may exhibit an Naf service-based interface.

The data network 436 may represent various network operator services, Internet access, or third party services that may be provided by one or more servers including, for example, application/content server 438.

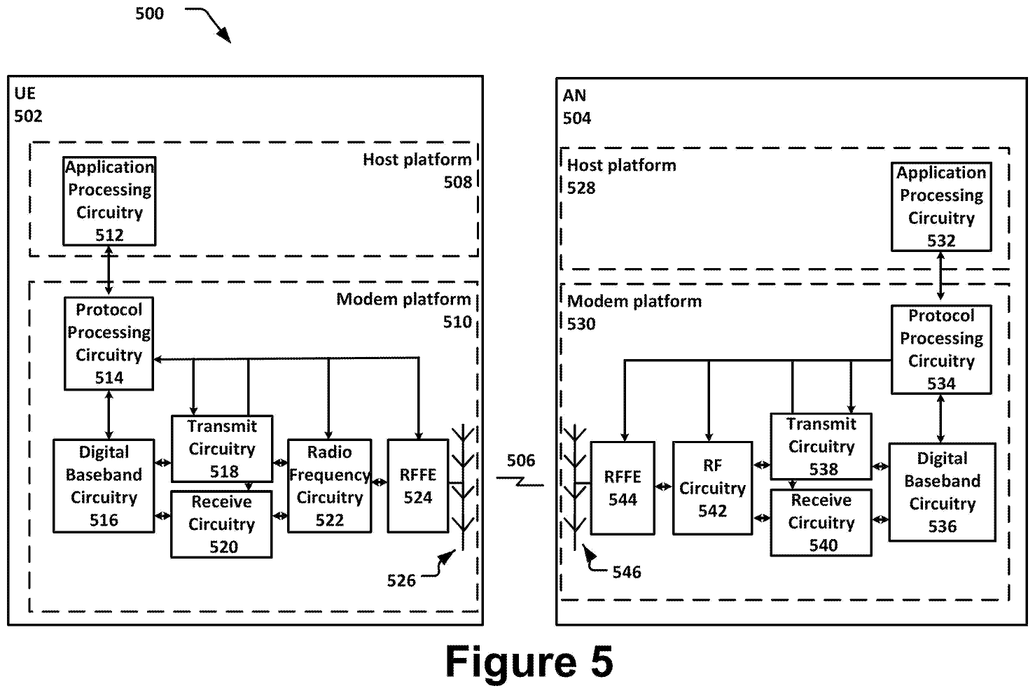

FIG. 5 schematically illustrates a wireless network 500 in accordance with various embodiments. The wireless network 500 may include a UE 502 in wireless communication with an AN 504. The UE 502 and AN 504 may be similar to, and substantially interchangeable with, like-named components described elsewhere herein.

The UE 502 may be communicatively coupled with the AN 504 via connection 506. The connection 506 is illustrated as an air interface to enable communicative coupling, and can be consistent with cellular communications protocols such as an LTE protocol or a 5G NR protocol operating at mmWave or sub-6 GHz frequencies.

The UE 502 may include a host platform 508 coupled with a modem platform 510. The host platform 508 may include application processing circuitry 512, which may be coupled with protocol processing circuitry 514 of the modem platform 510. The application processing circuitry 512 may run various applications for the UE 502 that source/sink application data. The application processing circuitry 512 may further implement one or more layer operations to transmit/receive application data to/from a data network. These layer operations may include transport (for example UDP) and Internet (for example, IP) operations The protocol processing circuitry 514 may implement one or more of layer operations to facilitate transmission or reception of data over the connection 506. The layer operations implemented by the protocol processing circuitry 514 may include, for example, MAC, RLC, PDCP, RRC and NAS operations.

The modem platform 510 may further include digital baseband circuitry 516 that may implement one or more layer operations that are “below” layer operations performed by the protocol processing circuitry 514 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 510 may further include transmit circuitry 518, receive circuitry 520, RF circuitry 522, and RF front end (RFFE) 524, which may include or connect to one or more antenna panels 526. Briefly, the transmit circuitry 518 may include a digital-to-analog converter, mixer, intermediate frequency (IF) components, etc.; the receive circuitry 520 may include an analog-to-digital converter, mixer, IF components, etc.; the RF circuitry 522 may include a low-noise amplifier, a power amplifier, power tracking components, etc.; RFFE 524 may include filters (for example, surface/bulk acoustic wave filters), switches, antenna tuners, beamforming components (for example, phase-array antenna components), etc. The selection and arrangement of the components of the transmit circuitry 518, receive circuitry 520, RF circuitry 522, RFFE 524, and antenna panels 526 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 514 may include one or more instances of control circuitry (not shown) to provide control functions for the transmit/receive components.

A UE reception may be established by and via the antenna panels 526, RFFE 524, RF circuitry 522, receive circuitry 520, digital baseband circuitry 516, and protocol processing circuitry 514. In some embodiments, the antenna panels 526 may receive a transmission from the AN 504 by receive-beamforming signals received by a plurality of antennas/antenna elements of the one or more antenna panels 526.

A UE transmission may be established by and via the protocol processing circuitry 514, digital baseband circuitry 516, transmit circuitry 518, RF circuitry 522, RFFE 524, and antenna panels 526. In some embodiments, the transmit components of the UE 504 may apply a spatial filter to the data to be transmitted to form a transmit beam emitted by the antenna elements of the antenna panels 526.

Similar to the UE 502, the AN 504 may include a host platform 528 coupled with a modem platform 530. The host platform 528 may include application processing circuitry 532 coupled with protocol processing circuitry 534 of the modem platform 530. The modem platform may further include digital baseband circuitry 536, transmit circuitry 538, receive circuitry 540, RF circuitry 542, RFFE circuitry 544, and antenna panels 546. The components of the AN 504 may be similar to and substantially interchangeable with like-named components of the UE 502. In addition to performing data transmission/reception as described above, the components of the AN 508 may perform various logical functions that include, for example, RNC functions such as radio bearer management, uplink and downlink dynamic radio resource management, and data packet scheduling.

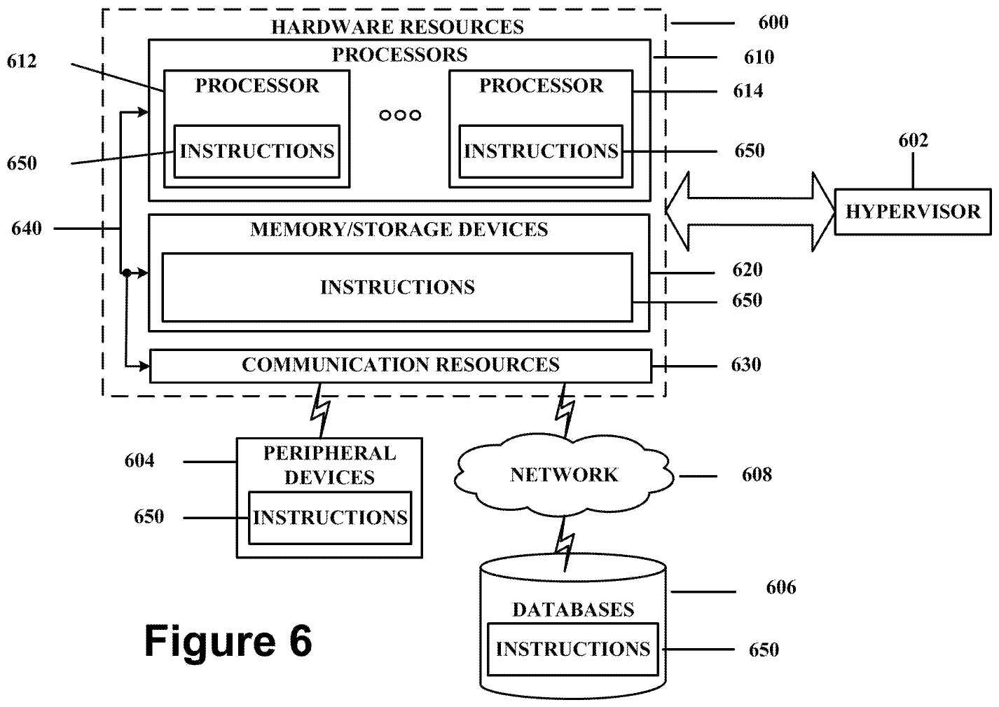

FIG. 6 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 6 shows a diagrammatic representation of hardware resources 600 including one or more processors (or processor cores) 610, one or more memory/storage devices 620, and one or more communication resources 630, each of which may be communicatively coupled via a bus 640 or other interface circuitry. For embodiments where node virtualization (e.g., NFV) is utilized, a hypervisor 602 may be executed to provide an execution environment for one or more network slices/sub-slices to utilize the hardware resources 600.

The processors 610 may include, for example, a processor 612 and a processor 614. The processors 610 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 620 may include main memory, disk storage, or any suitable combination thereof. The memory/storage devices 620 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 630 may include interconnection or network interface controllers, components, or other suitable devices to communicate with one or more peripheral devices 604 or one or more databases 606 or other network elements via a network 608. For example, the communication resources 630 may include wired communication components (e.g., for coupling via USB, Ethernet, etc.), cellular communication components, NFC components, Bluetooth® (or Bluetooth® Low Energy) components, Wi-Fi® components, and other communication components.

Instructions 650 may comprise software, a program, an application, an applet, an app, or other executable code for causing at least any of the processors 610 to perform any one or more of the methodologies discussed herein. The instructions 650 may reside, completely or partially, within at least one of the processors 610 (e.g., within the processor's cache memory), the memory/storage devices 620, or any suitable combination thereof. Furthermore, any portion of the instructions 650 may be transferred to the hardware resources 600 from any combination of the peripheral devices 604 or the databases 606. Accordingly, the memory of processors 610, the memory/storage devices 620, the peripheral devices 604, and the databases 606 are examples of computer-readable and machine-readable media.

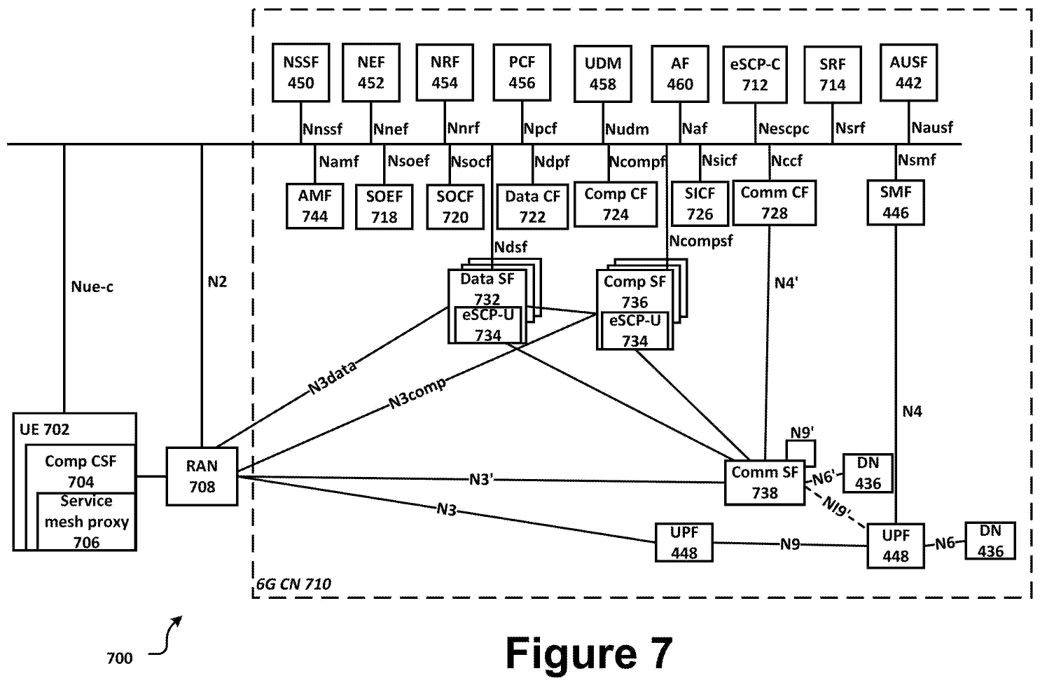

FIG. 7 illustrates a network 700 in accordance with various embodiments. The network 700 may operate in a matter consistent with 3GPP technical specifications or technical reports for 6G systems. In some embodiments, the network 700 may operate concurrently with network 400. For example, in some embodiments, the network 700 may share one or more frequency or bandwidth resources with network 400. As one specific example, a UE (e.g., UE 702) may be configured to operate in both network 700 and network 400. Such configuration may be based on a UE including circuitry configured for communication with frequency and bandwidth resources of both networks 400 and 700. In general, several elements of network 700 may share one or more characteristics with elements of network 400. For the sake of brevity and clarity, such elements may not be repeated in the description of network 700.

The network 700 may include a UE 702, which may include any mobile or non-mobile computing device designed to communicate with a RAN 708 via an over-the-air connection. The UE 702 may be similar to, for example, UE 402. The UE 702 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 7, in some embodiments the network 700 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 7, the UE 702 may be communicatively coupled with an AP such as AP 406 as described with respect to FIG. 4. Additionally, although not specifically shown in FIG. 7, in some embodiments the RAN 708 may include one or more ANss such as AN 408 as described with respect to FIG. 4. The RAN 708 and/or the AN of the RAN 708 may be referred to as a base station (BS), a RAN node, or using some other term or name.

The UE 702 and the RAN 708 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 708 may allow for communication between the UE 702 and a 6G core network (CN) 710. Specifically, the RAN 708 may facilitate the transmission and reception of data between the UE 702 and the 6G CN 710. The 6G CN 710 may include various functions such as NSSF 450, NEF 452, NRF 454, PCF 456, UDM 458, AF 460, SMF 446, and AUSF 442. The 6G CN 710 may additional include UPF 448 and DN 436 as shown in FIG. 7.

Additionally, the RAN 708 may include various additional functions that are in addition to, or alternative to, functions of a legacy cellular network such as a 4G or 5G network. Two such functions may include a Compute Control Function (Comp CF) 724 and a Compute Service Function (Comp SF) 736. The Comp CF 724 and the Comp SF 736 may be parts or functions of the Computing Service Plane. Comp CF 724 may be a control plane function that provides functionalities such as management of the Comp SF 736, computing task context generation and management (e.g., create, read, modify, delete), interaction with the underlaying computing infrastructure for computing resource management, etc. Comp SF 736 may be a user plane function that serves as the gateway to interface computing service users (such as UE 702) and computing nodes behind a Comp SF instance. Some functionalities of the Comp SF 736 may include: parse computing service data received from users to compute tasks executable by computing nodes; hold service mesh ingress gateway or service API gateway; service and charging policies enforcement; performance monitoring and telemetry collection, etc. In some embodiments, a Comp SF 736 instance may serve as the user plane gateway for a cluster of computing nodes. A Comp CF 724 instance may control one or more Comp SF 736 instances.

Two other such functions may include a Communication Control Function (Comm CF) 728 and a Communication Service Function (Comm SF) 738, which may be parts of the Communication Service Plane. The Comm CF 728 may be the control plane function for managing the Comm SF 738, communication sessions creation/configuration/releasing, and managing communication session context. The Comm SF 738 may be a user plane function for data transport. Comm CF 728 and Comm SF 738 may be considered as upgrades of SMF 446 and UPF 448, which were described with respect to a 5G system in FIG. 4. The upgrades provided by the Comm CF 728 and the Comm SF 738 may enable service-aware transport. For legacy (e.g., 4G or 5G) data transport, SMF 446 and UPF 448 may still be used.

Two other such functions may include a Data Control Function (Data CF) 722 and Data Service Function (Data SF) 732 may be parts of the Data Service Plane. Data CF 722 may be a control plane function and provides functionalities such as Data SF 732 management, Data service creation/configuration/releasing, Data service context management, etc. Data SF 732 may be a user plane function and serve as the gateway between data service users (such as UE 702 and the various functions of the 6G CN 710) and data service endpoints behind the gateway. Specific functionalities may include include: parse data service user data and forward to corresponding data service endpoints, generate charging data, report data service status.

Another such function may be the Service Orchestration and Chaining Function (SOCF) 720, which may discover, orchestrate and chain up communication/computing/data services provided by functions in the network. Upon receiving service requests from users, SOCF 720 may interact with one or more of Comp CF 724, Comm CF 728, and Data CF 722 to identify Comp SF 736, Comm SF 738, and Data SF 732 instances, configure service resources, and generate the service chain, which could contain multiple Comp SF 736, Comm SF 738, and Data SF 732 instances and their associated computing endpoints. Workload processing and data movement may then be conducted within the generated service chain. The SOCF 720 may also responsible for maintaining, updating, and releasing a created service chain.

Another such function may be the service registration function (SRF) 714, which may act as a registry for system services provided in the user plane such as services provided by service endpoints behind Comp SF 736 and Data SF 732 gateways and services provided by the UE 702. The SRF 714 may be considered a counterpart of NRF 454, which may act as the registry for network functions.

Other such functions may include an evolved service communication proxy (eSCP) and service infrastructure control function (SICF) 726, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 712 and eSCP-U 734, for control plane service communication proxy and user plane service communication proxy, respectively. The SICF 726 may control and configure eCSP instances in terms of service traffic routing policies, access rules, load balancing configurations, performance monitoring, etc.

Another such function is the AMF 744. The AMF 744 may be similar to 444, but with additional functionality. Specifically, the AMF 744 may include potential functional repartition, such as move the message forwarding functionality from the AMF 744 to the RAN 708.

Another such function is the service orchestration exposure function (SOEF) 718. The SOEF may be configured to expose service orchestration and chaining services to external users such as applications.

The UE 702 may include an additional function that is referred to as a computing client service function (comp CSF) 704. The comp CSF 704 may have both the control plane functionalities and user plane functionalities, and may interact with corresponding network side functions such as SOCF 720, Comp CF 724, Comp SF 736, Data CF 722, and/or Data SF 732 for service discovery, request/response, compute task workload exchange, etc. The Comp CSF 704 may also work with network side functions to decide on whether a computing task should be run on the UE 702, the RAN 708, and/or an element of the 6G CN 710.

The UE 702 and/or the Comp CSF 704 may include a service mesh proxy 706. The service mesh proxy 706 may act as a proxy for service-to-service communication in the user plane. Capabilities of the service mesh proxy 706 may include one or more of addressing, security, load balancing, etc.

### Example Procedures

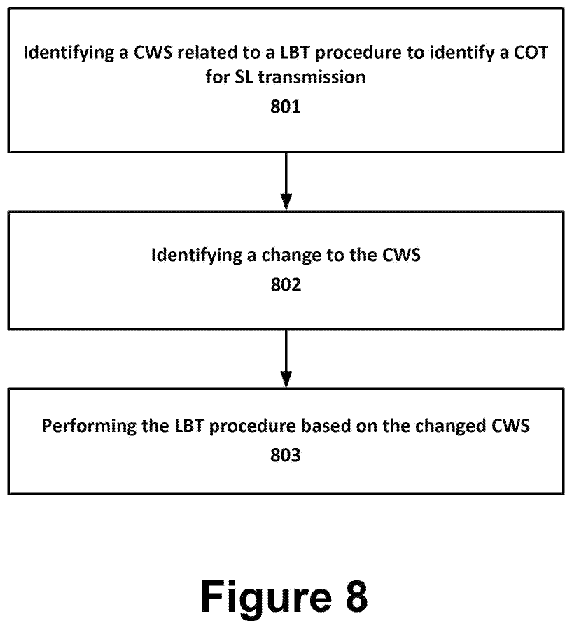

In some embodiments, the electronic device(s), network(s), system(s), chip(s) or component(s), or portions or implementations thereof, of FIGS. 4-7, or some other figure herein, may be configured to perform one or more processes, techniques, or methods as described herein, or portions thereof. One such process is depicted in FIG. 8. Specifically, FIG. 8 may relate to a method to be performed by a user equipment (UE), one or more elements of a UE, or an electronic device that includes a UE. The process may include identifying, at 801, a contention window size (CWS) related to a listen before talk (LBT) procedure to identify a channel occupancy time (COT) for sidelink (SL) transmission; identifying, at 802, a change to the CWS; and performing, at 803, the LBT procedure based on the changed CWS.

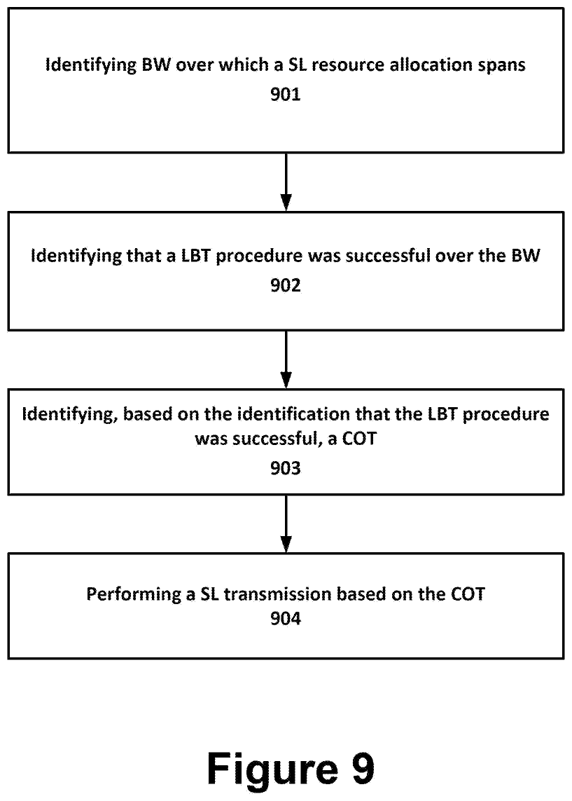

Another such process is depicted in FIG. 9. Specifically, FIG. 9 may relate to a method to be performed by a user equipment (UE), one or more elements of a UE, and/or one or more electronic devices that include and/or implement a UE. The process may include identifying, at 901, bandwidth (BW) over which a sidelink (SL) resource allocation spans; identifying, at 902, that a listen before talk (LBT) procedure was successful over the BW; identifying, at 903 based on the identification that the LBT procedure was successful, a channel occupancy time (COT); and performing, at 904, a SL transmission based on the COT.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include this disclosure provides details regarding the CWS adjustment mechanism for NR SL systems operating in FR-1 unlicensed band, when type 1 LBT procedure is used

Example 2 may include the methods to adapt the contention window size for NR SL systems operating in FR-1 unlicensed band, when type 1 LBT procedure is used

Example 3 may include the methods to define the LBT measurement bandwidth based on the resource pool configuration

Example 4 may include the methods to adjust the energy detection threshold based on SL physical channels and procedure

Example 5 may include the methods to the relate the LBT measurement BW, and the frequency allocation for SL communication in unlicensed spectrum

Example 6 includes a method to be performed by a user equipment (UE), one or more elements of a UE, or an electronic device that includes a UE, wherein the method comprises: identifying a contention window size (CWS) related to a listen before talk (LBT) procedure to identify a channel occupancy time (COT) for sidelink (SL) transmission; identifying a change to the CWS; and performing the LBT procedure based on the changed CWS.

Example 7 includes the method of example 6 and/or some other example herein, wherein the change to the CWS is based on HARQ-ACK feedback.

Example 8 includes the method of example 7 and/or some other example herein, wherein the HARQ-ACK feedback is received from a fifth generation (5G) nodeB (gNB).

Example 9 includes the method of example 7 and/or some other example herein, wherein the HARQ-ACK feedback is received from another UE.

Example 10 includes the method of any of examples 6-9, and/or some other example herein, wherein the change is based on information received during a reference time.

Example 11 includes the method of any of examples 6-10, and/or some other example herein, wherein the SL transmission is a NR-U SL transmission.

Example 12 includes the method of any of examples 6-11, and/or some other example herein, wherein the HARQ-ACK feedback includes only a NACK.

Example 13 includes the method of any of examples 6-11, and/or some other example herein, wherein the HARQ-ACK feedback includes a NACK and an ACK.

Example 14 includes the method of any of examples 6-11, and/or some other example herein, wherein the HARQ-ACK feedback includes only an ACK.

Example 15 includes the method of any of examples 6-11, and/or some other example herein, wherein the method further comprises transmitting the SL transmission in any LBT bandwidth (BW) for which the LBT procedure succeeds.

Example 16 includes the method of any of examples 6-11, and/or some other example herein, wherein the method further comprises transmitting the SL transmission only if the LBT succeeds in every LBT bandwidth (BW).

Example 17 includes a method to be performed by a user equipment (UE), one or more elements of a UE, and/or one or more electronic devices that include and/or implement a UE, wherein the method comprises: identifying bandwidth (BW) over which a sidelink (SL) resource allocation spans; identifying that a listen before talk (LBT) procedure was successful over the BW; identifying, based on the identification that the LBT procedure was successful, a channel occupancy time (COT); and performing a SL transmission based on the COT.

Example 18 includes the method of example 17, and/or some other example herein, wherein the UE is operating in a dynamic channel access mode.

Example 19 includes the method of any of examples 17-18, and/or some other example herein, wherein the SL transmission is a physical sidelink shared channel (PSSCH) transmission.

Example 20 includes the method of any of examples 17-18, and/or some other example herein, wherein the SL transmission is a physical SL control channel (PSCCH) transmission.

Example 21 includes the method of any of examples 17-20, and/or some other example herein, wherein the BW is a multiple of 20 megahertz (MHz).

Example 22 includes the method of any of examples 17-21, and/or some other example herein, wherein the COT is identified based on an identification that the LBT procedure was successful across an entirety of the BW over which the SL resource allocation spans.

Example 23 includes the method of any of examples 17-22, and/or some other example herein, wherein the LBT procedure is a type 1 LBT procedure.

Example 24 includes a method to be performed by a user equipment (UE), one or more elements of a UE, and/or one or more electronic devices that include and/or implement a UE, wherein the method comprises: identifying a contention window size (CWS) related to a listen before talk (LBT) procedure to identify a channel occupancy time (COT) for sidelink (SL) transmission; identifying a change to the CWS; and performing the LBT procedure based on the changed CWS.

Example 25 includes the method of example 24, and/or some other example herein, wherein the change to the CWS is based on information received during a reference time.

Example 26 includes the method of any of examples 24-25, and/or some other example herein, wherein the change to the CWS is based on HARQ-ACK feedback.

Example 27 includes the method of any of examples 24-26, and/or some other example herein, wherein the instructions are further to transmit the SL transmission in one or more LBT bandwidths (BWs) for which the LBT procedure succeeds.

Example 28 includes the method of example 27, and/or some other example herein, wherein the SL transmission spans a plurality of LBT BWs.

Example 29 includes the method of any of examples 24-28, and/or some other example herein, wherein the instructions are further to transmit the SL transmission only if the LBT succeeds in every LBT bandwidth (BW).

Example 30 includes the method of example 29, and/or some other example herein, wherein the SL transmission spans a plurality of LBT BWs.

Example 31 includes a method to be performed by a user equipment (UE), one or more elements of a UE, and/or one or more electronic devices that include and/or implement a UE, wherein the method comprises: identifying that the UE is operating in a dynamic channel access mode; identifying bandwidth (BW) over which a sidelink (SL) resource allocation spans; identifying that a listen before talk (LBT) procedure was successful over at least a portion of the BW; identifying, based on the identification that the LBT procedure was successful, a channel occupancy time (COT); and performing a SL transmission based on the COT.

Example 32 includes the method of example 31, and/or some other example herein, wherein the method further comprises: identifying that the LBT procedure was successful over the entirety of the BW; and performing the SL transmission; wherein the UE is to not perform the SL transmission if the LBT procedure was not successful over the entirety of the BW.

Example 33 includes the method of example 32, and/or some other example herein, wherein the SL transmission is a physical SL shared channel (PSSCH) transmission or a physical SL control channel (PSCCH) transmission.

Example 34 includes the method of example 31, and/or some other example herein, wherein the method further comprises: performing the SL transmission in a portion of the BW in which the LBT procedure is successful; and not performing the SL transmission in a portion of the BW in which the LBT procedure is not successful.

Example 35 includes the method of example 34, and/or some other example herein, wherein the SL transmission is a physical SL feedback channel (PSFCH) transmission.

Example 36 includes the method of any of examples 31-35, and/or some other example herein, wherein the BW is a multiple of 20 megahertz (MHz).

Example 37 includes the method of any of examples 31-36, and/or some other example herein, wherein the LBT procedure is a type 1 LBT procedure.

Example Z01 may include an apparatus comprising means to perform one or more elements of a method described in or related to any of examples 1-37, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-37, or any other method or process described herein.

Example Z03 may include an apparatus comprising logic, modules, or circuitry to perform one or more elements of a method described in or related to any of examples 1-37, or any other method or process described herein.

Example Z04 may include a method, technique, or process as described in or related to any of examples 1-37, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-37, or portions thereof.

Example Z06 may include a signal as described in or related to any of examples 1-37, or portions or parts thereof.

Example Z07 may include a datagram, packet, frame, segment, protocol data unit (PDU), or message as described in or related to any of examples 1-37, or portions or parts thereof, or otherwise described in the present disclosure.

Example Z08 may include a signal encoded with data as described in or related to any of examples 1-37, or portions or parts thereof, or otherwise described in the present disclosure.

Example Z09 may include a signal encoded with a datagram, packet, frame, segment, protocol data unit (PDU), or message as described in or related to any of examples 1-37, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-37, or portions thereof.

Example Z11 may include a computer program comprising instructions, wherein execution of the program by a processing element is to cause the processing element to carry out the method, techniques, or process as described in or related to any of examples 1-37, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019 June). For the purposes of the present document, the following abbreviations may apply to the examples and embodiments discussed herein.

3GPP Third Generation Partnership Project
4G Fourth Generation
5G Fifth Generation
5GC 5G Core network
AC Application Client
ACR Application Context Relocation
ACK Acknowledgement
ACID Application Client Identification
AF Application Function
AM Acknowledged Mode
AMBRAggregate Maximum Bit Rate
AMF Access and Mobility Management Function
AN Access Network
ANR Automatic Neighbour Relation
AOA Angle of Arrival
AP Application Protocol, Antenna Port, Access Point
API Application Programming Interface
APN Access Point Name
ARP Allocation and Retention Priority
ARQ Automatic Repeat Request
AS Access Stratum
ASP Application Service Provider
ASN.1 Abstract Syntax Notation One
AUSF Authentication Server Function
AWGN Additive White Gaussian Noise
BAP Backhaul Adaptation Protocol
BCH Broadcast Channel
BER Bit Error Ratio
BFD Beam Failure Detection
BLER Block Error Rate
BPSK Binary Phase Shift Keying
BRAS Broadband Remote Access Server
BSS Business Support System
BS Base Station
BSR Buffer Status Report
BW Bandwidth
BWP Bandwidth Part
C-RNTI Cell Radio Network Temporary Identity
CA Carrier Aggregation, Certification Authority
CAPEX CAPital Expenditure
CBD Candidate Beam Detection
CBRA Contention Based Random Access
CC Component Carrier, Country Code, Cryptographic Checksum
CCA Clear Channel Assessment
CCE Control Channel Element
CCCH Common Control Channel
CE Coverage Enhancement
CDM Content Delivery Network
CDMA Code-Division Multiple Access
CDR Charging Data Request
CDR Charging Data Response
CFRA Contention Free Random Access
CG Cell Group
CGF Charging Gateway Function
CHF Charging Function
CI Cell Identity
CID Cell-ID (e.g., positioning method)
CIM Common Information Model
CIR Carrier to Interference Ratio
CK Cipher Key
CM Connection Management, Conditional Mandatory
CMAS Commercial Mobile Alert Service
CMD Command
CMS Cloud Management System
CO Conditional Optional
CoMP Coordinated Multi-Point
CORESET Control Resource Set
COTS Commercial Off-The-Shelf
CP Control Plane, Cyclic Prefix, Connection Point
CPD Connection Point Descriptor
CPE Customer Premise Equipment
CPICHCommon Pilot Channel
CQI Channel Quality Indicator
CPU CSI processing unit, Central Processing Unit
C/R Command/Response field bit
CRAN Cloud Radio Access Network, Cloud RAN
CRB Common Resource Block
CRC Cyclic Redundancy Check
CRI Channel-State Information Resource Indicator,
CSI-RS Resource Indicator
C-RNTI Cell RNTI
CS Circuit Switched
CSCF call session control function
CSAR Cloud Service Archive
CSI Channel-State Information
CSI-IM CSI Interference Measurement
CSI-RS CSI Reference Signal
CSI-RSRP CSI reference signal received power
CSI-RSRQ CSI reference signal received quality
CSI-SINR CSI signal-to-noise and interference ratio
CSMA Carrier Sense Multiple Access
CSMA/CA CSMA with collision avoidance
CSS Common Search Space, Cell- specific Search Space
CTF Charging Trigger Function
CTS Clear-to-Send
CW Codeword
CWS Contention Window Size
D2D Device-to-Device
DC Dual Connectivity, Direct Current
DCI Downlink Control Information
DF Deployment Flavour
DL Downlink
DMTF Distributed Management Task Force
DPDK Data Plane Development Kit
DM-RS, DMRS Demodulation Reference Signal
DN Data network
DNN Data Network Name
DNAI Data Network Access Identifier
DRB Data Radio Bearer
DRS Discovery Reference Signal
DRX Discontinuous Reception
DSL Domain Specific Language. Digital Subscriber Line
DSLAM DSL Access Multiplexer
DwPTS Downlink Pilot Time Slot
E-LAN Ethernet Local Area Network
E2E End-to-End
EAS Edge Application Server
ECCA extended clear channel assessment, extended CCA
ECCE Enhanced Control Channel Element, Enhanced CCE
ED Energy Detection
EDGE Enhanced Datarates for GSM Evolution (GSM Evolution)
EAS Edge Application Server
EASID Edge Application Server Identification
ECS Edge Configuration Server
ECSP Edge Computing Service Provider
EDN Edge Data Network
EEC Edge Enabler Client
EECID Edge Enabler Client Identification
EES Edge Enabler Server
EESID Edge Enabler Server Identification
EHE Edge Hosting Environment
EGMF Exposure Governance Management Function
EGPRS Enhanced GPRS
EIR Equipment Identity Register
eLAA enhanced Licensed Assisted Access, enhanced LAA
EM Element Manager
eMBB Enhanced Mobile Broadband
EMS Element Management System
eNB evolved NodeB, E-UTRAN Node B
EN-DC E-UTRA-NR Dual Connectivity
EPC Evolved Packet Core
EPDCCH enhanced PDCCH, enhanced Physical Downlink Control Cannel
EPRE Energy per resource element
EPS Evolved Packet System
EREG enhanced REG, enhanced resource element groups
ETSI European Telecommunications Standards Institute
ETWS Earthquake and Tsunami Warning System
eUICC embedded UICC, embedded Universal Integrated Circuit Card
E-UTRA Evolved UTRA
E-UTRAN Evolved UTRAN
EV2X Enhanced V2X
F1AP F1 Application Protocol
F1-C F1 Control plane interface
F1-U F1 User plane interface
FACCH Fast Associated Control CHannel
FACCH/F Fast Associated Control Channel/Full rate
FACCH/H Fast Associated Control Channel/Half rate
FACH Forward Access Channel
FAUSCH Fast Uplink Signalling Channel
FB Functional Block
FBI Feedback Information
FCC Federal Communications Commission
FCCH Frequency Correction CHannel
FDD Frequency Division Duplex
FDM Frequency Division Multiplex
FDMAFrequency Division Multiple Access
FE Front End
FEC Forward Error Correction
FFS For Further Study
FFT Fast Fourier Transformation
feLAA further enhanced Licensed Assisted Access, further enhanced LAA
FN Frame Number
FPGA Field-Programmable Gate Array
FR Frequency Range
FQDN Fully Qualified Domain Name
G-RNTI GERAN Radio Network Temporary Identity
GERAN GSM EDGE RAN, GSM EDGE Radio Access Network
GGSN Gateway GPRS Support Node
GLONASS GLObal’naya NAvigatsionnaya Sputnikovaya Sistema
(Engl.: Global Navigation Satellite System)
gNB Next Generation NodeB
gNB-CU gNB-centralized unit, Next Generation NodeB centralized unit
gNB-DU gNB-distributed unit, Next Generation NodeB distributed unit
GNSS Global Navigation Satellite System
GPRS General Packet Radio Service
GPSI Generic Public Subscription Identifier
GSM Global System for Mobile Communications, Groupe Spécial Mobile
GTP GPRS Tunneling Protocol
GTP-UGPRS Tunnelling Protocol for User Plane
GTS Go To Sleep Signal (related to WUS)
GUMMEI Globally Unique MME Identifier
GUTI Globally Unique Temporary UE Identity
HARQ Hybrid ARQ, Hybrid Automatic Repeat Request
HANDO Handover
HFN HyperFrame Number
HHO Hard Handover
HLR Home Location Register
HN Home Network
HO Handover
HPLMN Home Public Land Mobile Network
HSDPA High Speed Downlink Packet Access
HSN Hopping Sequence Number
HSPA High Speed Packet Access
HSS Home Subscriber Server
HSUPA High Speed Uplink Packet Access
HTTP Hyper Text Transfer Protocol
HTTPS Hyper Text Transfer Protocol Secure
(https is http/1.1 over SSL, i.e. port 443)
I-Block Information Block
ICCID Integrated Circuit Card Identification
IAB Integrated Access and Backhaul
ICIC Inter-Cell Interference Coordination
ID Identity, identifier
IDFT Inverse Discrete Fourier Transform
IE Information element
IBE In-Band Emission
IEEE Institute of Electrical and Electronics Engineers
IEI Information Element Identifier
IEIDL Information Element Identifier Data Length
IETF Internet Engineering Task Force
IF Infrastructure
IIOT Industrial Internet of Things
IM Interference Measurement, Intermodulation, IP Multimedia
IMC IMS Credentials
IMEI International Mobile Equipment Identity
IMGI International mobile group identity
IMPI IP Multimedia Private Identity
IMPU IP Multimedia PUblic identity
IMS IP Multimedia Subsystem
IMSI International Mobile Subscriber Identity
IoT Internet of Things
IP Internet Protocol
Ipsec IP Security, Internet Protocol Security
IP-CAN IP-Connectivity Access Network
IP-M IP Multicast
IPv4 Internet Protocol Version 4
IPv6 Internet Protocol Version 6
IR Infrared
IS In Sync
IRP Integration Reference Point
ISDN Integrated Services Digital Network
ISIM IM Services Identity Module
ISO International Organisation for Standardisation
ISP Internet Service Provider
IWF Interworking-Function
I-WLAN Interworking WLAN
Constraint length of the convolutional code, USIM Individual key
kB Kilobyte (1000 bytes)
kbps kilo-bits per second
Kc Ciphering key
Ki Individual subscriber authentication key
KPI Key Performance Indicator
KQI Key Quality Indicator
KSI Key Set Identifier
ksps kilo-symbols per second
KVM Kernel Virtual Machine
L1 Layer 1 (physical layer)
L1-RSRP Layer 1 reference signal received power
L2 Layer 2 (data link layer)
L3 Layer 3 (network layer)
LAA Licensed Assisted Access
LAN Local Area Network
LADN Local Area Data Network
LBT Listen Before Talk
LCM LifeCycle Management
LCR Low Chip Rate
LCS Location Services
LCID Logical Channel ID
LI Layer Indicator
LLC Logical Link Control, Low Layer Compatibility
LMF Location Management Function
LOS Line of Sight
LPLMN Local PLMN
LPP LTE Positioning Protocol
LSB Least Significant Bit
LTE Long Term Evolution
LWA LTE-WLAN aggregation
LWIP LTE/WLAN Radio Level Integration with IPsec Tunnel
LTE Long Term Evolution
M2M Machine-to-Machine
MAC Medium Access Control (protocol layering context)
MAC Message authentication code (security/encryption context)
MAC-A MAC used for authentication and key agreement
(TSG T WG3 context)
MAC-IMAC used for data integrity of signalling messages
(TSG T WG3 context)
MANO Management and Orchestration
MBMS Multimedia Broadcast and Multicast Service
MBSFN Multimedia Broadcast multicast service
Single Frequency Network
MCC Mobile Country Code
MCG Master Cell Group
MCOTMaximum Channel Occupancy Time
MCS Modulation and coding scheme
MDAFManagement Data Analytics Function
MDASManagement Data Analytics Service
MDT Minimization of Drive Tests
ME Mobile Equipment
MeNB master eNB
MER Message Error Ratio
MGL Measurement Gap Length
MGRP Measurement Gap Repetition Period
MIB Master Information Block, Management Information Base
MIMO Multiple Input Multiple Output
MLC Mobile Location Centre
MM Mobility Management
MME Mobility Management Entity
MN Master Node
MNO Mobile Network Operator
MO Measurement Object, Mobile Originated
MPBCH MTC Physical Broadcast CHannel
MPDCCH MTC Physical Downlink Control CHannel
MPDSCH MTC Physical Downlink Shared CHannel
MPRACH MTC Physical Random Access CHannel
MPUSCH MTC Physical Uplink Shared Channel
MPLS MultiProtocol Label Switching
MS Mobile Station
MSB Most Significant Bit
MSC Mobile Switching Centre
MSI Minimum System Information,
MCH Scheduling Information
MSID Mobile Station Identifier
MSIN Mobile Station Identification Number
MSISDN Mobile Subscriber ISDN Number
MT Mobile Terminated, Mobile Termination
MTC Machine-Type Communications
mMTCmassive MTC, massive Machine-Type Communications
MU-MIMO Multi User MIMO
MWUS MTC wake-up signal, MTC WUS
NACK Negative Acknowledgement
NAI Network Access Identifier
NAS Non-Access Stratum, Non- Access Stratum layer
NCT Network Connectivity Topology
NC-JT Non-Coherent Joint Transmission
NEC Network Capability Exposure
NE-DC NR-E-UTRA Dual Connectivity
NEF Network Exposure Function
NF Network Function
NFP Network Forwarding Path
NFPD Network Forwarding Path Descriptor
NFV Network Functions Virtualization
NFVI NFV Infrastructure
NFVO NFV Orchestrator
NG Next Generation, Next Gen
NGEN-DC NG-RAN E-UTRA-NR Dual Connectivity
NM Network Manager
NMS Network Management System
N-PoP Network Point of Presence
NMIB, N-MIB Narrowband MIB
NPBCH Narrowband Physical Broadcast CHannel
NPDCCH Narrowband Physical Downlink Control CHannel
NPDSCH Narrowband Physical Downlink Shared CHannel
NPRACH Narrowband Physical Random Access CHannel
NPUSCH Narrowband Physical Uplink Shared CHannel
NPSS Narrowband Primary Synchronization Signal
NSSS Narrowband Secondary Synchronization Signal
NR New Radio, Neighbour Relation
NRF NF Repository Function
NRS Narrowband Reference Signal
NS Network Service
NSA Non-Standalone operation mode
NSD Network Service Descriptor
NSR Network Service Record
NSSAINetwork Slice Selection Assistance Information
S-NNSAI Single-NSSAI
NSSF Network Slice Selection Function
NW Network
NWUSNarrowband wake-up signal, Narrowband WUS
NZP Non-Zero Power
O&M Operation and Maintenance
ODU2 Optical channel Data Unit - type 2
OFDMOrthogonal Frequency Division Multiplexing
OFDMA Orthogonal Frequency Division Multiple Access
OOB Out-of-Band
OOS Out of Sync
OPEX OPerating EXpense
OSI Other System Information
OSS Operations Support System
OTA over-the-air
PAPR Peak-to-Average Power Ratio
PAR Peak to Average Ratio
PBCH Physical Broadcast Channel
PC Power Control, Personal Computer
PCC Primary Component Carrier, Primary CC
P-CSCF Proxy CSCF
PCell Primary Cell
PCI Physical Cell ID, Physical Cell Identity
PCEF Policy and Charging Enforcement Function
PCF Policy Control Function
PCRF Policy Control and Charging Rules Function
PDCP Packet Data Convergence Protocol,
Packet Data Convergence Protocol layer
PDCCH Physical Downlink Control Channel
PDCP Packet Data Convergence Protocol
PDN Packet Data Network, Public Data Network
PDSCH Physical Downlink Shared Channel
PDU Protocol Data Unit
PEI Permanent Equipment Identifiers
PFD Packet Flow Description
P-GW PDN Gateway
PHICH Physical hybrid-ARQ indicator channel
PHY Physical layer
PLMN Public Land Mobile Network
PIN Personal Identification Number
PM Performance Measurement
PMI Precoding Matrix Indicator
PNF Physical Network Function
PNFD Physical Network Function Descriptor
PNFR Physical Network Function Record
POC PTT over Cellular
PP, PTP Point-to-Point
PPP Point-to-Point Protocol
PRACH Physical RACH
PRB Physical resource block
PRG Physical resource block group
ProSe Proximity Services, Proximity-Based Service
PRS Positioning Reference Signal
PRR Packet Reception Radio
PS Packet Services
PSBCH Physical Sidelink Broadcast Channel
PSDCH Physical Sidelink Downlink Channel
PSCCH Physical Sidelink Control Channel
PSSCH Physical Sidelink Shared Channel
PSFCH physical sidelink feedback channel
PSCell Primary SCell
PSS Primary Synchronization Signal
PSTN Public Switched Telephone Network
PT-RS Phase-tracking reference signal
PTT Push-to-Talk
PUCCH Physical Uplink Control Channel
PUSCH Physical Uplink Shared Channel
QAM Quadrature Amplitude Modulation
QCI QoS class of identifier
QCL Quasi co-location
QFI QoS Flow ID, QoS Flow Identifier
QoS Quality of Service
QPSK Quadrature (Quarternary) Phase Shift Keying
QZSS Quasi-Zenith Satellite System
RA-RNTI Random Access RNTI
RAB Radio Access Bearer, Random Access Burst
RACH Random Access Channel
RADIUS Remote Authentication Dial In User Service
RAN Radio Access Network
RAND RANDom number (used for authentication)
RAR Random Access Response
RAT Radio Access Technology
RAU Routing Area Update
RB Resource block, Radio Bearer
RBG Resource block group
REG Resource Element Group
Rel Release
REQ REQuest
RF Radio Frequency
RI Rank Indicator
RIV Resource indicator value
RL Radio Link
RLC Radio Link Control, Radio Link Control layer
RLC AM RLC Acknowledged Mode
RLC UM RLC Unacknowledged Mode
RLF Radio Link Failure
RLM Radio Link Monitoring
RLM-RS Reference Signal for RLM
RM Registration Management
RMC Reference Measurement Channel
RMSI Remaining MSI, Remaining Minimum System Information
RN Relay Node
RNC Radio Network Controller
RNL Radio Network Layer
RNTI Radio Network Temporary Identifier
ROHC RObust Header Compression
RRC Radio Resource Control, Radio Resource Control layer
RRM Radio Resource Management
RS Reference Signal
RSRP Reference Signal Received Power
RSRQ Reference Signal Received Quality
RSSI Received Signal Strength Indicator
RSU Road Side Unit
RSTD Reference Signal Time difference
RTP Real Time Protocol
RTS Ready-To-Send
RTT Round Trip Time
Rx Reception, Receiving, Receiver
S1AP S1 Application Protocol
S1-MME S1 for the control plane
S1-U S1 for the user plane
S-CSCF serving CSCF
S-GW Serving Gateway
S-RNTI SRNC Radio Network Temporary Identity
S-TMSI SAE Temporary Mobile Station Identifier
SA Standalone operation mode
SAE System Architecture Evolution
SAP Service Access Point
SAPD Service Access Point Descriptor
SAPI Service Access Point Identifier
SCC Secondary Component Carrier, Secondary CC
SCell Secondary Cell
SCEF Service Capability Exposure Function
SC-FDMA Single Carrier Frequency Division Multiple Access
SCG Secondary Cell Group
SCM Security Context Management
SCS Subcarrier Spacing
SCTP Stream Control Transmission Protocol
SDAP Service Data Adaptation Protocol,
Service Data Adaptation Protocol layer
SDL Supplementary Downlink
SDNF Structured Data Storage Network Function
SDP Session Description Protocol
SDSF Structured Data Storage Function
SDT Small Data Transmission
SDU Service Data Unit
SEAF Security Anchor Function
SeNB secondary eNB
SEPP Security Edge Protection Proxy
SFI Slot format indication
SFTD Space-Frequency Time Diversity, SFN and frame timing difference
SFN System Frame Number
SgNB secondary gNB
SGSN Serving GPRS Support Node
S-GW Serving Gateway
SI System Information
SI-RNTI System Information RNTI
SIB System Information Block
SIM Subscriber Identity Module
SIP Session Initiated Protocol
SiP System in Package
SL Sidelink
SLA Service Level Agreement
SM Session Management
SMF Session Management Function
SMS Short Message Service
SMSF SMS Function
SMTC SSB-based Measurement Timing Configuration
SN Secondary Node, Sequence Number
SoC System on Chip
SON Self-Organizing Network
SpCell Special Cell
SP-CSI-RNTISemi-Persistent CSI RNTI
SPS Semi-Persistent Scheduling
SQN Sequence number
SR Scheduling Request
SRB Signalling Radio Bearer
SRS Sounding Reference Signal
SS Synchronization Signal
SSB Synchronization Signal Block
SSID Service Set Identifier
SS/PBCH Block SSBRI SS/PBCH Block Resource Indicator,
Synchronization Signal Block Resource Indicator
SSC Session and Service Continuity
SS-RSRP Synchronization Signal based Reference Signal
Received Power
SS-RSRQ Synchronization Signal based Reference Signal
Received Quality
SS-SINR Synchronization Signal based Signal to Noise
and Interference Ratio
SSS Secondary Synchronization Signal
SSSG Search Space Set Group
SSSIF Search Space Set Indicator
SST Slice/Service Types
SU-MIMO Single User MIMO
SUL Supplementary Uplink
TA Timing Advance, Tracking Area
TAC Tracking Area Code
TAG Timing Advance Group
TAI Tracking Area Identity
TAU Tracking Area Update
TB Transport Block
TBS Transport Block Size
TBD To Be Defined
TCI Transmission Configuration Indicator
TCP Transmission Communication Protocol
TDD Time Division Duplex
TDM Time Division Multiplexing
TDMATime Division Multiple Access
TE Terminal Equipment
TEID Tunnel End Point Identifier
TFT Traffic Flow Template
TMSI Temporary Mobile Subscriber Identity
TNL Transport Network Layer
TPC Transmit Power Control
TPMI Transmitted Precoding Matrix Indicator
TR Technical Report
TRP, TRxP Transmission Reception Point
TRS Tracking Reference Signal
TRx Transceiver
TS Technical Specifications, Technical Standard
TTI Transmission Time Interval
Tx Transmission, Transmitting, Transmitter
U-RNTI UTRAN Radio Network Temporary Identity
UART Universal Asynchronous Receiver and Transmitter
UCI Uplink Control Information
UE User Equipment
UDM Unified Data Management
UDP User Datagram Protocol
USDF Unstructured Data Storage Network Function
UICC Universal Integrated Circuit Card
UL Uplink
UM Unacknowledged Mode
UML Unified Modelling Language
UMTS Universal Mobile Telecommunications System
UP User Plane
UPF User Plane Function
URI Uniform Resource Identifier
URL Uniform Resource Locator
URLLC Ultra-Reliable and Low Latency
USB Universal Serial Bus
USIM Universal Subscriber Identity Module
USS UE-Specific search space
UTRA UMTS Terrestrial Radio Access
UTRAN Universal Terrestrial Radio Access Network
UwPTS Uplink Pilot Time Slot
V2I Vehicle-to-Infrastruction
V2P Vehicle-to-Pedestrian
V2V Vehicle-to-Vehicle
V2X Vehicle-to-everything
VIM Virtualized Infrastructure Manager
VL Virtual Link,
VLAN Virtual LAN, Virtual Local Area Network
VM Virtual Machine
VNF Virtualized Network Function
VNFFG VNF Forwarding Graph
VNFFGD VNF Forwarding Graph Descriptor
VNFMVNF Manager
VoIP Voice-over-IP, Voice-over- Internet Protocol
VPLMN Visited Public Land Mobile Network
VPN Virtual Private Network
VRB Virtual Resource Block
WiMAX Worldwide Interoperability for Microwave Access
WLANWireless Local Area Network
WMAN Wireless Metropolitan Area Network
WPANWireless Personal Area Network
X2-C X2-Control plane
X2-U X2-User plane
XML eXtensible Markup Language
XRES EXpected user RESponse
XOR eXclusive OR
ZC Zadoff-Chu
ZP Zero Power

### Terminology

For the purposes of the present document, the following terms and definitions are applicable to the examples and embodiments discussed herein.

The term “application” may refer to a complete and deployable package, environment to achieve a certain function in an operational environment. The term “AI/ML application” or the like may be an application that contains some AI/ML models and application-level descriptions.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), descisions tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

1.-20. (canceled)

21. An apparatus for use in a user equipment (UE), wherein the apparatus comprises:
memory to store information on a contention window size (CWS) related to a listen before talk (LBT) procedure to identify a channel occupancy time (COT) for sidelink (SL) transmission; and
one or more processors configured to:
identify a change to the CWS; and
facilitate performance, by the UE, of the LBT procedure based on the changed CWS.

22. The apparatus of claim 21, wherein the change to the CWS is based on information received during a reference time.

23. The apparatus of claim 21, wherein the change to the CWS is based on HARQ-ACK feedback.

24. The apparatus of claim 21, wherein the one or more processors are further to facilitate transmission, by the UE, of the SL transmission in one or more LBT bandwidths (BWs) for which the LBT procedure succeeds.

25. The apparatus of claim 24, wherein the SL transmission spans a plurality of LBT BWs.

26. The apparatus of claim 21, wherein the one or more processors are further to facilitate transmission, by the UE, of the SL transmission only if the LBT succeeds in every LBT bandwidth (BW).

27. The apparatus of claim 26, wherein the SL transmission spans a plurality of LBT BWs.

28. A user equipment (UE) comprising:
radio frequency (RF) circuitry to facilitate wireless communication; and
one or more processors coupled with the RF circuitry, wherein the one or more processors are to:
identify that the UE is operating in a dynamic channel access mode;
identify bandwidth (BW) over which a sidelink (SL) resource allocation spans;
identify that a listen before talk (LBT) procedure was successful over at least a portion of the BW;
identify, based on the identification that the LBT procedure was successful, a channel occupancy time (COT); and
perform a SL transmission based on the COT.

29. The UE of claim 28, wherein the one or more processors are further to:
identify that the LBT procedure was successful over the entirety of the BW; and
perform the SL transmission;
wherein the UE is to not perform the SL transmission if the LBT procedure was not successful over the entirety of the BW.

30. The UE of claim 29, wherein the SL transmission is a physical SL shared channel (PSSCH) transmission or a physical SL control channel (PSCCH) transmission.

31. The UE of claim 28, wherein the UE is further to:
perform the SL transmission in a portion of the BW in which the LBT procedure is successful; and
not perform the SL transmission in a portion of the BW in which the LBT procedure is not successful.

32. The UE of claim 31, wherein the SL transmission is a physical SL feedback channel (PSFCH) transmission.

33. The UE of claim 28, wherein the BW is a multiple of 20 megahertz (MHz).

34. The UE of claim 28, wherein the LBT procedure is a type 1 LBT procedure.

35. One or more non-transitory computer-readable media (NTCRM) comprising instructions that, upon execution of the instructions by one or more processors of a user equipment (UE), are to cause the UE to:
identify that the UE is operating in a dynamic channel access mode;
identify bandwidth (BW) over which a sidelink (SL) resource allocation spans;
identify that a type 1 listen before talk (LBT) procedure was successful over at least a portion of the BW;
identify, based on the identification that the LBT procedure was successful, a channel occupancy time (COT); and
perform a SL transmission based on the COT.

36. The one or more NTCRM of claim 35, wherein the instructions are further to:
identify that the LBT procedure was successful over the entirety of the BW; and
perform the SL transmission;
wherein the UE is to not perform the SL transmission if the LBT procedure was not successful over the entirety of the BW.

37. The one or more NTCRM of claim 36, wherein the SL transmission is a physical SL shared channel (PSSCH) transmission or a physical SL control channel (PSCCH) transmission.

38. The one or more NTCRM of claim 35, wherein the instructions are further to:
perform the SL transmission in a portion of the BW in which the LBT procedure is successful; and
not perform the SL transmission in a portion of the BW in which the LBT procedure is not successful.

39. The one or more NTCRM of claim 38, wherein the SL transmission is a physical SL feedback channel (PSFCH) transmission.

40. The one or more NTCRM of claim 35, wherein the BW is a multiple of 20 megahertz (MHz).
